(19) United States
(12) Patent Application Publication
(10) Pub. No.: US 2025/0067971 A1
(43) Pub. Date: Feb. 27, 2025

(54) TUNABLE OPTICAL CAVITY AND OPTOELECTRONIC SYSTEM EMPLOYING THE SAME

(71) Applicant: KOREA ADVANCED INSTITUTE OF SCIENCE AND TECHNOLOGY, Daejeon (KR)

(72) Inventor: Kyoungsik YU, Daejeon (KR)

(73) Assignee: KOREA ADVANCED INSTITUTE OF SCIENCE AND TECHNOLOGY, Daejeon (KR)

(21) Appl. No.: 18/798,191

(22) Filed: Aug. 8, 2024

(30) Foreign Application Priority Data
Aug. 23, 2023 (KR) 10-2023-0110770
May 8, 2024 (KR) 10-2024-0060839

(51) Int. Cl. G02B 26/06; G02B 6/26

(52) U.S. Cl. CPC G02B 26/06; G02B 6/262

(57) ABSTRACT

A tunable optical cavity and an optoelectronic system employing the same are disclosed. The tunable optical cavity includes a waveguide provided to include first and second optical coupler loops, and a cavity waveguide therebetween, a tunable phase shifter that shifts a phase of light proceeding the cavity waveguide, and a controller. The tunable phase shifter includes a perturbation waveguide arranged in parallel with a straight waveguide portion of the cavity waveguide and a first actuator that moves one of the cavity waveguide and the perturbation waveguide in a first moving direction as a first movable waveguide. The controller controls a driving signal applied to the first actuator to adjust an effective cavity length between the first and second optical coupler loops. Each of the first and second optical coupler loops includes a first waveguide portion and a second waveguide portion arranged in parallel with each other to occur an optical coupling therebetween.

### CROSS-REFERENCE TO RELATED APPLICATIONS

This application is based on and claims priority under 35 U.S.C. § 119 to Korean Patent Application Nos. 10-2023-0110770, filed on Aug. 23, 2023, and 10-2024-0060839, filed on May 8, 2024, in the Korean Intellectual Property Office, the disclosures of which are incorporated by reference herein in their entirety.

### BACKGROUND

### 1. Field

The disclosure relates to a tunable optical cavity and an optoelectronic system including the tunable optical cavity.

This work was supported by the Samsung Future Technology Development Project (Task Number:SRFC-IT2002-04)

### 2. Description of the Related Art

Most integrated lasers are implemented in a Fabry-Pérot cavity. In order to tune the emission characteristics of a laser (e.g., emission wavelength, output power, linewidth, etc.), a resonance wavelength and a transmissivity of a cavity are required to be tunable. However, because cavity tuning is mostly based on a thermal method that consumes high electrical power, due to thermal crosstalk of tuning elements, unwanted shift and hopping of an emission lasing wavelength may be caused.

### SUMMARY

Provided is a tunable optical cavity including a tunable phase shifter and a tunable optical coupler and capable of tuning at low electrical power without generating heat.

Provided is a tunable optical cavity that may be implemented on a silicon photonic MEMS platform.

Provided is an optoelectronic system including a tunable optical cavity.

Additional aspects will be set forth in part in the description which follows and, in part, will be apparent from the description, or may be learned by practice of the presented embodiments of the disclosure.

According to one or more embodiments, a tunable optical cavity includes a waveguide provided to include a first optical coupler loop provided on an input terminal side, a second optical coupler loop provided on an output terminal side, and a cavity waveguide therebetween, a tunable phase shifter configured to shift a phase of light proceeding the cavity waveguide by including a perturbation waveguide arranged in parallel with a straight waveguide portion of the cavity waveguide and a first actuator that moves one of the cavity waveguide and the perturbation waveguide in a first moving direction as a first movable waveguide, and a controller configured to control a driving signal applied to the first actuator to adjust an effective cavity length between the first optical coupler loop and the second optical coupler loop by adjusting an amount of light phase shift by the tunable phase shifter, wherein each of the first and second optical coupler loops includes a first waveguide portion and a second waveguide portion arranged in parallel with each other and a loop waveguide portion connecting the first waveguide portion and the second waveguide portion, and an optical coupling occurs between the first waveguide portion and the second waveguide portion.

The first moving direction may be a horizontal direction or a vertical direction.

The perturbation waveguide and the cavity waveguide may have different cross-sectional sizes.

The perturbation waveguide may have a less cross-sectional size than the cavity waveguide.

The first movable waveguide may be the perturbation waveguide.

The first actuator may be a micro-electromechanical system (MEMS)-based actuator.

The first actuator may be provided to adjust in a direction in which the cavity waveguide and the perturbation waveguide become closer when a driving signal is input thereto.

The first actuator may be provided to move one of the cavity waveguide and the perturbation waveguide in the first moving direction, wherein the first actuator may include a first fixed part and a first movable part provided to be movable with respect to the first fixed part to move one of the cavity waveguide and the perturbation waveguide as the first movable waveguide in the first moving direction, and the first fixed part and the first movable part may be formed with combs engaging with each other without collision in a direction in which the first movable part moves or in a direction forming an angle with respect to a first driving axis of the first movable part.

A driving signal may be applied from the controller to the first fixed part of the first actuator, and the first movable part may be electrically grounded and driven in an electrostatic manner.

The tunable phase shifter may include a plurality of tunable phase shifters, and the perturbation waveguide may include a plurality of perturbation waveguides arranged along the cavity waveguide in parallel with a straight waveguide portion of the cavity waveguide and spaced apart from each other to form the plurality of tunable phase shifters, and the first actuator may include a plurality of first actuators provided to correspond to each of the perturbation waveguides, wherein each of the plurality of tunable phase shifters may include one perturbation waveguide and one first actuator.

The first optical coupler loop may be provided to form a first tunable optical coupler, and the second optical coupler loop may be provided to form a second tunable optical coupler, wherein each of the first and second tunable optical couplers may include a second actuator provided to move one of the first waveguide portion and the second waveguide portion of each of the first and second optical coupler loops as a second movable waveguide in a second moving direction crossing a plane including the first moving direction to adjust an optical coupling between the first waveguide portion and the second waveguide portion.

The second moving direction may be a vertical direction or the horizontal direction, the second actuator may be provided to move one of the first waveguide portion and the second waveguide portion as the second movable waveguide in the second moving direction.

The second actuator may include a second fixed part and a second movable part for moving the second moving waveguide in the second moving direction under control of the controller, wherein the second fixed part and the second movable part may have combs engaging with each other without collision in a direction forming an angle with respect to a second driving axis of the second movable part or in a direction in which the second movable part moves.

A driving signal may be applied to the second fixed part of the second actuator, and the second movable part may be electrically grounded and driven in an electrostatic manner.

Any one of the first and second optical coupler loops may be provided to form a tunable optical coupler, wherein the tunable optical coupler may include a second actuator provided to move any one of the first and second waveguide portions arranged in parallel with each other in the optical coupler loop as a second movable waveguide in a second moving direction crossing a plane including the first moving direction to adjust an optical coupling between the first waveguide portion and the second waveguide portion.

The second moving direction may be a vertical direction or a horizontal direction, and the second actuator may be provided to move one of the first waveguide portion and the second waveguide portion as the second movable waveguide in the second moving direction.

The second actuator may include a second fixed part and a second movable part for moving the second movable waveguide in the second moving direction under control of the controller, wherein the second fixed part and the second movable part may have combs engaging with each other without collision in a direction forming an angle with respect to the second driving axis of the second movable part or in a direction in which the second movable part moves.

A driving signal may be applied to the second fixed part of the second actuator, and the second movable part may be electrically grounded and driven in an electrostatic manner.

Other of the first and second optical coupler loops may be a fixed type.

According to one or more embodiments, an optoelectronic system includes the tunable optical cavity described above and a light providing part configured to provide light input to the tunable optical cavity through an input terminal of the tunable optical cavity.

The light providing part may be configured to provide laser light.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic conceptual diagram of a tunable optical cavity according to an embodiment;

FIG. 2 illustrates a waveguide of FIG. 1;

FIG. 3 illustrates an example of implementing a tunable optical cavity according to an embodiment on a silicon photonic MEMS platform;

FIG. 4 is an enlarged view of a first actuator of FIG. 3;

FIG. 5 illustrates a horizontal movement of a first movable waveguide by driving of a first actuator in a tunable optical cavity according to an embodiment;

FIG. 6 is a plan view illustrating a first actuator of a tunable phase shifter applied to a tunable optical cavity according to an embodiment;

FIG. 7 is an enlarged view of a fixed comb and a movable comb of FIG. 6;

FIG. 8 is an enlarged view of a spring structure of FIG. 6;

FIG. 9 is a cross-sectional view illustrating a design example of a fixed waveguide and a first movable waveguide of a tunable phase shifter;

FIG. 10 is a graph showing simulation results of a phase shift amount by three tunable phase shifters to which the design example of FIG. 9 is applied;

FIG. 11 is diagram showing an enlarged view of a tunable optical coupler that may be applied to the tunable optical cavity according to the embodiment of FIG. 3;

FIG. 12 illustrates an optical coupler loop of FIG. 11;

FIG. 13 illustrates a movement of a second movable waveguide in a vertical direction by driving a second actuator in the optical coupler loop of FIG. 11;

FIG. 14 is a schematic plan view illustrating an example of a second actuator of a tunable optical coupler applied to a tunable optical cavity according to an embodiment;

FIG. 15 is a cross-sectional view taken along line A-A′ of FIG. 14;

FIG. 16 is a cross-sectional view taken along line B-B′ of FIG. 14;

FIGS. 17A and 17B illustrate a design example of a tunable optical coupler of a tunable optical cavity according to an embodiment. FIG. 17A is a plan view of a section in which the tunable optical coupler is formed, and FIG. 17B is a schematic cross-sectional view taken along line C-C′ of FIG. 17A;

FIG. 17C is a graph showing a change in optical coupling efficiency according to driving of a tunable optical coupler to which the design examples of FIGS. 17A and 17B are applied;

FIG. 18 is a graph showing measured transmissivity and reflectivity of a tunable optical coupler applied to a tunable optical cavity according to the embodiment according to an applied voltage;

FIGS. 19A and 19B are graphs showing a measured transmission spectrum response and a measured transmission linewidth (FWHM) of the tunable optical cavity according to an embodiment;

FIG. 20A is a graph showing a shift of a resonance peak of a transmission signal of a tunable optical cavity according to an embodiment, and FIG. 20B is a graph showing an enlarged portion of a section of FIG. 20A;

FIGS. 21A and 21B are graphs showing current change and electrical power consumption measured in a tunable optical coupler over time when a voltage is applied to a tunable optical coupler applied to a tunable optical cavity according to an embodiment, respectively;

FIGS. 22A and 22B are graphs showing current change and electrical power consumption measured in a tunable phase shifter over time when a voltage is applied to a tunable phase shifter applied to a tunable optical cavity according to an embodiment, respectively;

FIG. 23 is a graph showing transmission power measured at a resonance peak when various voltages are applied to second tunable optical coupler at an output terminal of a tunable optical cavity according to an embodiment;

FIG. 24 is a graph showing a resonance wavelength shift Δλ measured when various voltages are applied to a tunable phase shifter of a tunable optical cavity according to an embodiment;

FIGS. 25 to 28 are schematic conceptual diagrams of tunable cavities according to various embodiments; and

FIG. 29 is a schematic diagram showing an optoelectronic system including a tunable optical cavity according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereafter, the embodiments will be described more fully with reference to the accompanying drawings, In the drawings, like reference numerals refer to like elements throughout, and sizes of elements in the drawings may be exaggerated for clarity and convenience of explanation In addition, example embodiments may be variously modified and may be embodied in many different forms.

When a position of an element is described using an expression “above” or “on”, the position of the element may include not only the element being “immediately on/under/left/right in a contact manner” but also being “on/under/left/right in a non-contact manner”. The singular forms include the plural forms unless the context clearly indicates otherwise. If a portion “includes” an element, another element may be further included, rather than excluding the existence of the other element, unless otherwise described.

The term “above” and similar directional terms may be applied to both singular and plural. With respect to operations that constitute a method, the operations may be performed in any appropriate sequence unless the sequence of operations is clearly described or unless the context clearly indicates otherwise. The operations may not necessarily be performed in the order of sequence.

Also, in the specification, the terms “units” or “ . . . modules” denote units or modules that process at least one function or operation, and may be realized by hardware, software, or a combination of hardware and software.

Connections or connection members of lines between components shown in the drawings illustrate functional connections and/or physical or circuit connections, and the connections or connection members may be represented by replaceable or additional various functional connections, physical connections, or circuit connections in an actual apparatus.

All examples or example terms are simply used to explain in detail the technical scope of the inventive concept, and thus, the scope of the inventive concept is not limited by the examples or the example terms as long as it is not defined by the claims.

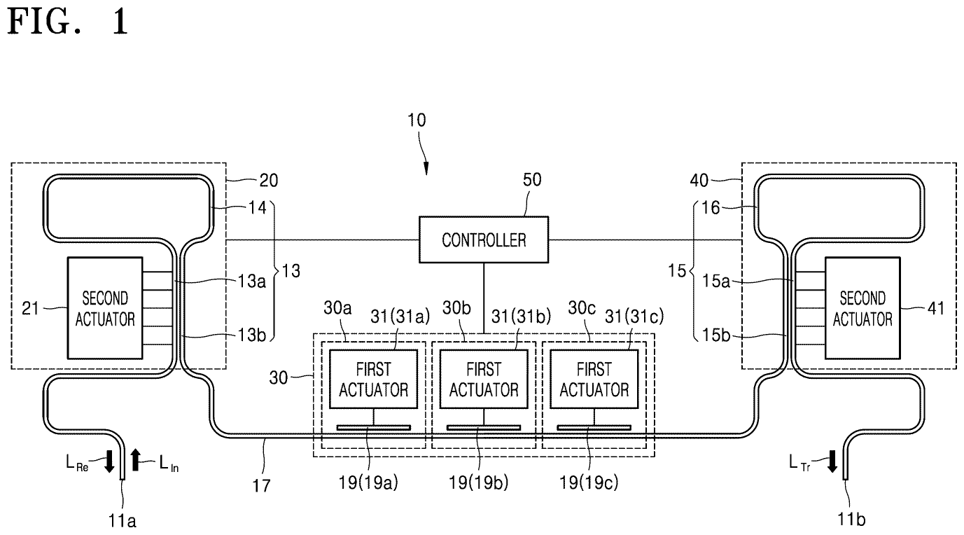

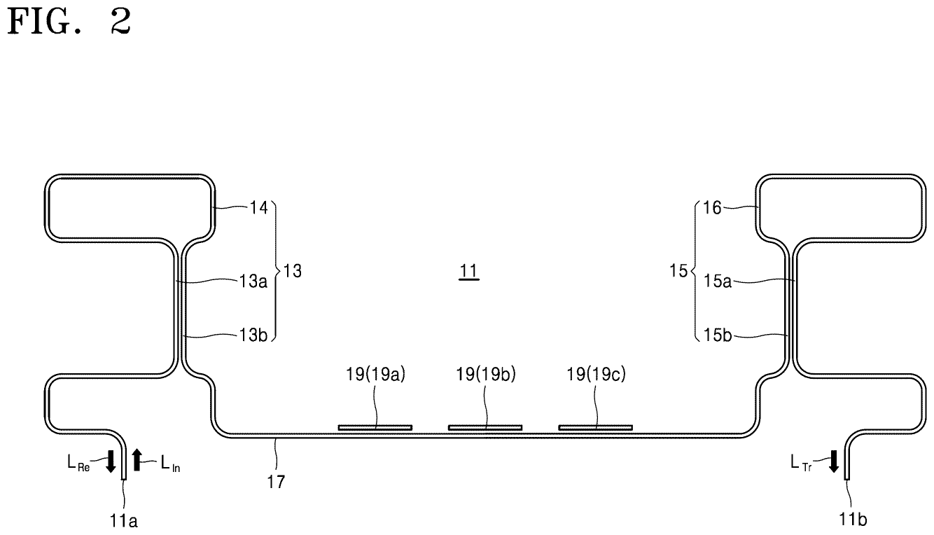

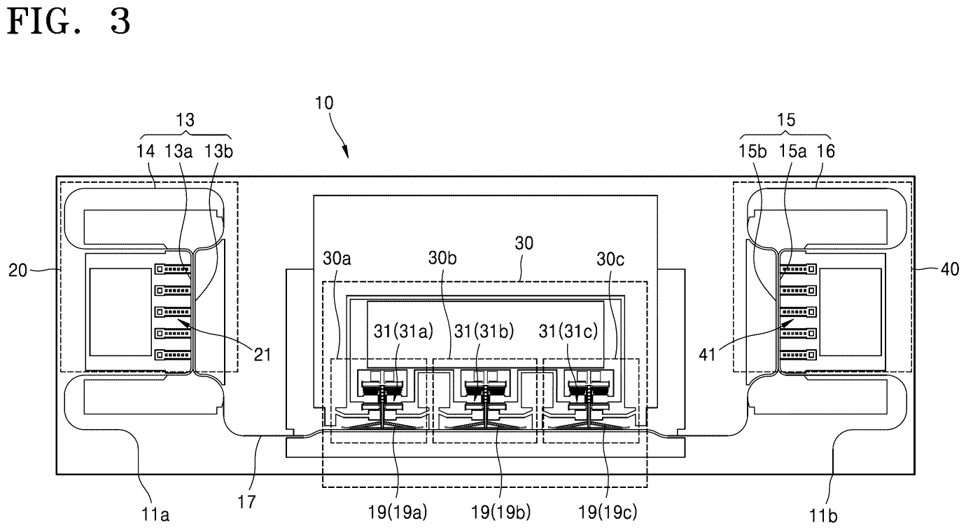

FIG. 1 is a schematic conceptual diagram of a tunable optical cavity 10 according to an embodiment. FIG. 2 illustrates a waveguide 11 of FIG. 1. FIG. 3 illustrates an example of implementing the tunable optical cavity 10 according to an embodiment on a silicon photonic MEMS platform.

Referring to FIGS. 1 to 3, the tunable optical cavity 10 according to an embodiment includes a waveguide 11 provided to form a cavity and a tunable phase shifter 30 that may change a phase of light traveling through the waveguide 11. A driving signal input to the tunable phase shifter 30 may be controlled by a controller 50. In the tunable optical cavity 10 according to an embodiment, the tunable phase shifter 30 may include one tunable phase shifter or a plurality of tunable phase shifters. FIGS. 1 to 3 illustrate an example in which the tunable optical cavity 10 according to an embodiment includes a plurality of tunable phase shifters 30. The tunable optical cavity 10 according to an embodiment may further include at least one tunable optical coupler 20 and/or 40. A driving signal input to the at least one tunable optical coupler 20 and/or 40 may be controlled by the controller 50.

Referring to FIG. 2, in the tunable optical cavity 10 according to an embodiment, the waveguide 11 may have an input terminal 11a and an output terminal 11b. The input terminal 11a of the waveguide 11 may be defined as an arbitrary point of the waveguide 11 before light propagating inside the waveguide 11 proceeds to the tunable optical cavity 10. The output terminal 11b of the waveguide 11 may be defined as an arbitrary point of the waveguide 11 through which light traveling through the tunable optical cavity 10 passes. In this case, the waveguide 11 may extend further than the input terminal 11a and output terminal 11b shown in FIGS. 1 and 2. As another example, at least one of the input terminal 11a and the output terminal 11b may be an end of the waveguide 11. For example, the input terminal 11a may be an end of the waveguide 11 through which light is incident into the tunable optical cavity 10, and the output terminal 11b may be an end of the waveguide 11 through which light traveling through the tunable optical cavity 10 is output. As another example, at least one of the input terminal 11a and the output terminal 11b may be an arbitrary point of the waveguide 11, and the other may be an end of the waveguide 11.

The waveguide 11 may be, for example, a single waveguide. The waveguide 11 may be provided to include a first optical coupler loop 13, a second optical coupler loop 15, and a cavity waveguide 17 therebetween. As described below, each of the first optical coupler loop 13 and the second optical coupler loop 15 may act as a reflector through optical coupling, thereby forming a cavity between the first optical coupler loop 13 and the second optical coupler loop 15. Accordingly, the tunable optical cavity 10 according to the embodiment may form a Fabry-Pérot tunable cavity.

The first optical coupler loop 13 may be provided on the input terminal 11a side, and the second optical coupler loop 15 may be provided on the output terminal 11b side. Input light L_{In} may be input to the waveguide 11 through the input terminal 11a. The input light L_{In} proceeds to the cavity waveguide 17 via the first optical coupler loop 13, and the light that proceeds the cavity waveguide 17 may be input to the second optical coupler loop 15. Light proceeding the second optical coupler loop 15 may be output through the output terminal 11b. The light output through the output terminal 11b may be referred to as transmission light L_{Tr}. Because each of the first optical coupler loop 13 and the second optical coupler loop 15 may act as a reflector by optical coupling, a portion of the light proceeding the first and second optical coupler loops 13 and 15 may be returned to the input terminal 11a and may be output through the input terminal 11a. The light output through the input terminal 11a may be referred to as reflection light L_{Re}. At least one of the first optical coupler loop 13 and the second optical coupler loop 15 may be provided to form a tunable optical coupler, and a ratio of the transmission light L_{Tr} output through the output terminal 11b and the reflection light L_{Re} output through the input terminal 11a may be adjusted according to the control of the tunable optical coupler. For example, as will be described later, when the tunable optical cavity 10 according to an embodiment includes a first tunable optical coupler 20 including the first optical coupler loop 13 and a second tunable optical coupler 40 including the second optical coupler loop 15, a ratio of the transmission light L_{Tr} output through the output terminal 11b and the reflection light L_{Re} output through the input terminal 11a may be adjusted according to the control of the optical coupling rate of each of the first tunable optical coupler 20 and the second tunable optical coupler 40.

According to the light coupling in the first optical coupler loop 13 and the light coupling in the second optical coupler loop 15, each of the first optical coupler loop 13 and the second optical coupler loop 15 may act as a reflector having a predetermined reflectivity, and a reflectance may be adjusted in the optical coupler loop forming the tunable optical coupler among the first optical coupler loop 13 and the second optical coupler loop 15. Accordingly, at least a portion of the transmission light L_{Tr} may be light that has been repeatedly proceeded the cavity waveguide 17 two or more times. Also, at least a portion of the reflection light L_{Re} may be light that has been repeatedly proceeded the cavity waveguide 17 two or more times.

Here, the output of the transmission light L_{Tr} and the reflection light L_{Re} refers to passing through the output terminal 11b and the input terminal 11a, but is not limited to being output through an end. For example, when the output terminal 11b corresponds to first arbitrary point of the waveguide 11 through which light traveling through the tunable optical cavity 10 passes, the output of the transmission light L_{Tr} may denote passing through the first arbitrary point of the waveguide 11 described above. In addition, when the input terminal 11a corresponds to second arbitrary point of the waveguide 11 before light propagating inside the waveguide 11 proceeds to the tunable optical cavity 10, the output of the reflection light L_{Re} may denote passing through the second arbitrary point of the waveguide 11 described above. When the output terminal 11b or the input terminal 11a consists of an end, the output of transmission light L_{Tr} or reflection light L_{Re} may denote output through the end.

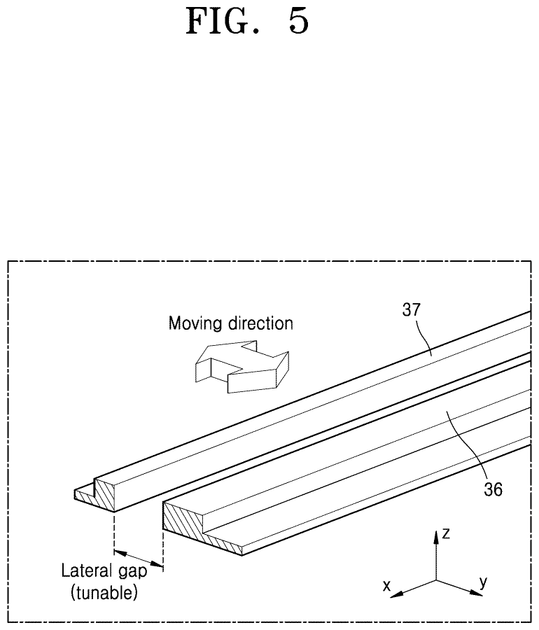

The tunable phase shifter 30 may be provided in a straight waveguide portion of the cavity waveguide 17 to tune a phase of light proceeding the cavity waveguide 17. The tunable phase shifter 30 may include a perturbation waveguide 19 arranged in parallel with the straight waveguide portion of the cavity waveguide 17 and a first actuator 31 that moves in a first moving direction using one of the straight waveguide portion of the cavity waveguide 17 and the perturbation waveguide 19 arranged in parallel with each other as a first movable waveguide 37 (refer to FIG. 5). The first actuator 31 may adjust a gap between the cavity waveguide 17 and the perturbation waveguide 19 in the first moving direction according to the driving signal controlled by the controller 50. When an effective refractive index of an optical mode of the cavity waveguide 17 changes due to the presence of the perturbation waveguide 19, a phase of light proceeding the cavity waveguide 17 may shift. When the gap between the cavity waveguide 17 and the perturbation waveguide 19 is adjusted, and as a result, an effective refractive index of an optical mode of the cavity waveguide 17 is varied, the amount of phase shift of the light proceeding the cavity waveguide 17 may be adjusted. The first moving direction may be, for example, a horizontal direction or a vertical direction. For example, the first actuator 31 may be provided to move either the cavity waveguide 17 or the perturbation waveguide 19 in the horizontal direction. Here, the horizontal direction may be a direction parallel to a plane on which the tunable optical cavity 10 according to the embodiment is disposed. For example, as illustrated in FIGS. 1 to 3, the first movable waveguide 37 may be the perturbation waveguide 19, and the first actuator 31 may be provided to move the perturbation waveguide 19 in the horizontal direction. As another example, the first movable waveguide 37 may be the cavity waveguide 17, and the first actuator 31 may be provided to move the cavity waveguide 17 in the horizontal direction. As another example, the first movable waveguide 37 may be the perturbation waveguide 19, and the first actuator 31 may be provided to move the perturbation waveguide 19 in the vertical direction. As still another example, the first movable waveguide 37 may be the cavity waveguide 17, and the first actuator 31 may be provided to move the cavity waveguide 17 in the vertical direction.

Meanwhile, as illustrated in FIGS. 1 to 3, the tunable optical cavity 10 according to the embodiment may be provided to include at least one tunable phase shifter 30, for example, a plurality of tunable phase shifters. To this end, the tunable optical cavity 10 according to the embodiment may include at least one perturbation waveguide 19 along the cavity waveguide 17 in parallel with the straight waveguide portion of the cavity waveguide 17, for example, a plurality of perturbation waveguides arranged along the cavity waveguide 17 to be spaced apart from each other and include a plurality of first actuators 31 provided to correspond to each of the plurality of perturbation waveguides 19.

For example, the tunable optical cavity 10 according to the embodiment may include first to third tunable phase shifters 30a, 30b, and 30c. The first tunable phase shifter 30a may include a first perturbation waveguide 19a, a straight waveguide portion of the cavity waveguide 17 corresponding to the first perturbation waveguide 19a, and a first actuator 31a provided to correspond to the first perturbation waveguide 19a. The second tunable phase shifter 30b may include a second perturbation waveguide 19b spaced apart from the first perturbation waveguide 19a, a straight waveguide portion of the cavity waveguide 17 corresponding to the second perturbation waveguide 19b, and a first actuator 31b provided to correspond to the second perturbation waveguide 19b. The third tunable phase shifter 30c may include a third perturbation waveguide 19c spaced apart from the second perturbation waveguide 19b, a straight waveguide portion of the cavity waveguide 17 corresponding to the third perturbation waveguide 19c, and a first actuator 31c provided corresponding to the third perturbation waveguide 19c. The first to third perturbation waveguides 19a, 19b, and 19c of the first to third tunable phase shifters 30a, 30b, and 30c may be spaced apart from each other and may be arranged along the cavity waveguide 17 in parallel to the straight waveguide portion of the cavity waveguide 17.

In FIGS. 1 to 3, as an example, it is illustrated that the tunable optical cavity 10 according to the embodiment includes three tunable phase shifters 30, but the embodiment is not limited thereto. As another example, the tunable optical cavity 10 according to the embodiment may be provided to include one, two, or four or more tunable phase shifters 30. The number of tunable phase shifters 30 may be selected depending on an amount of phase shift to be implemented.

In this way, the tunable optical cavity 10 according to the embodiment may include a plurality of tunable phase shifters 30. That is, the tunable optical cavity 10 according to the embodiment may include a plurality of perturbation waveguides 19 arranged in parallel with the straight waveguide portion of the cavity waveguide 17 and spaced apart from each other and include a plurality of first actuators 31 provided to correspond to the perturbation waveguides 19. At this time, each of the plurality of tunable phase shifters 30 may include one perturbation waveguide 19, a straight waveguide portion of the cavity waveguide 17 corresponding to the perturbation waveguide 19, and one first actuator 31. When the gap between the cavity waveguide 17 and the perturbation waveguide 19 in the first moving direction is adjusted by driving the first actuator 31 of each of the plurality of tunable phase shifters 30, an effective refractive index of an optical mode of the cavity waveguide 17 is changed, and thus, the phase of the light proceeding the cavity waveguide 17 may be shifted. The plurality of tunable phase shifters 30 may be controlled so that the amount of phase shift adjusted by each is the same. As another example, each of the plurality of tunable phase shifters 30 may be controlled independently from each other. Depending on an amount of phase shift to be implemented, only at least some of the plurality of tunable phase shifters 30 may be controlled to generate a phase shift.

In this way, when light phase shift amount is adjusted by the tunable phase shifter 30, an effective length of the cavity waveguide 17 may be adjusted, and an effective cavity length between the first optical coupler loop 13 and the second optical coupler loop 15 may be adjusted. Accordingly, because the first optical coupler loop 13 and the second optical coupler loop 15 each act as a reflector, the tunable optical cavity 10 according to the embodiment may form a Fabry-Pérot tunable cavity.

Meanwhile, the cavity waveguide 17 may correspond to a waveguide portion between the first optical coupler loop 13 and the second optical coupler loop 15. A cavity length may correspond to a waveguide length from a point where the light traveling through the input terminal 11a of the waveguide 11 meets the first optical coupler loop 13 to a point where the transmission light L_{Tr} passes through the second optical coupler loop 15 located on the output terminal 11b of the waveguide 11. That is, in the tunable optical cavity 10 according to the embodiment, the cavity length may include a waveguide length along which light traveling to and from the cavity waveguide 17 travels in the first optical coupler loop 13, a waveguide length along which the light traveling to and from the cavity waveguide 17 travels in the second optical coupler loop 15, and a length of the cavity waveguide 17. When the light phase shift amount is adjusted by the tunable phase shifter 30, the effective length of the cavity waveguide 17 may be adjusted, thereby adjusting the effective cavity length.

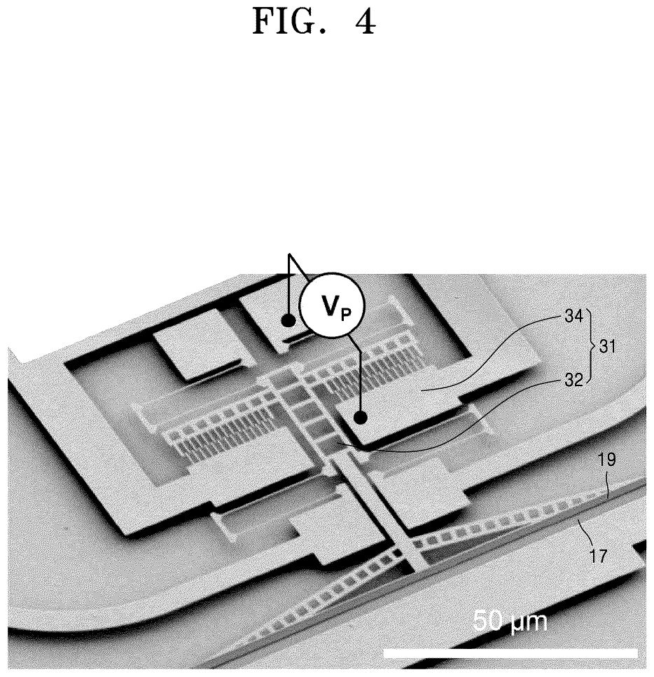

Hereinafter, the tunable phase shifter 30 applied to the tunable optical cavity 10 according to the embodiment will be described in more detail with reference to FIGS. 4 to 10.

FIG. 4 is an enlarged view of the first actuator 31 of FIG. 3. FIG. 5 illustrates a horizontal movement of the first movable waveguide 37 by driving the first actuator 31 in the tunable optical cavity 10 according to an embodiment.

Referring to FIGS. 3, 4, and 5, the first actuator 31 may be provided to move the first movable waveguide 37, for example, the perturbation waveguide 19, in the first moving direction, for example, the horizontal direction. When the perturbation waveguide 19 is operated by the first actuator 31, the cavity waveguide 17 may correspond to a fixed waveguide 36. As another example, the cavity waveguide 17 may be arranged to be operated by the first actuator 31, and in this case, the cavity waveguide 17 may correspond to the first movable waveguide 37 and the perturbation waveguide 19 may correspond to the fixed waveguide 36. Hereinafter, a case when the first actuator 31 is provided to move the perturbation waveguide 19 and the first moving direction for moving the perturbation waveguide 19 is the horizontal direction will be described as an example, but the embodiment is not limited thereto.

As illustrated in FIGS. 3 and 4, the first actuator 31 may be, for example, a MEMS-based actuator. As illustrated in FIG. 4, the first actuator 31 may include a first fixed part 34 and a first movable part 32 provided to operate with respect to the first fixed part 34 to move the perturbation waveguide 19. The first movable part 32 may be combined with the perturbation waveguide 19. The first actuator 31 may move the first movable part 32 with respect to the first fixed part 34 by a driving voltage Vp applied from the controller 50 to move the perturbation waveguide 19 coupled to the first movable part 32 in the first moving direction, for example, the horizontal direction.

As illustrated in FIG. 5, as the first movable waveguide 37, for example, the perturbation waveguide 19 moves in the horizontal direction by the driving voltage Vp applied from the controller 50 to the first actuator 31, a lateral gap between the first movable waveguide 37 and the first fixed waveguide 36, for example, between the perturbation waveguide 19 and the cavity waveguide 17 becomes tunable, and as a result, an effective refractive index of an optical mode of the cavity waveguide 17, which is a transmission waveguide, may change, thereby changing the phase of light proceeding the cavity waveguide 17.

According to the tunable optical cavity 10 according to an embodiment, the controller 50 may be provided to apply the driving voltage Vp to the first fixed part 34 of the first actuator 31. The first movable part 32 of the first actuator 31 may be, for example, electrically grounded. The first actuator 31 may be provided to be driven electrostatically. Accordingly, the first actuator 31 consumes electrical power only during operation, and the electrical power consumption during operation may also be very small.

Meanwhile, as shown in FIG. 5, the fixed waveguide 36 and the first movable waveguide 37, for example, the cavity waveguide 17 and the perturbing waveguide 19, may have different cross-sectional sizes. For example, the perturbation waveguide 19 may have a less cross-sectional size than the cavity waveguide 17. As another example, the perturbation waveguide 19 may have a greater cross-sectional size than the cavity waveguide 17. As another example, the cavity waveguide 17 and the perturbation waveguide 19 may have the same cross-sectional size.

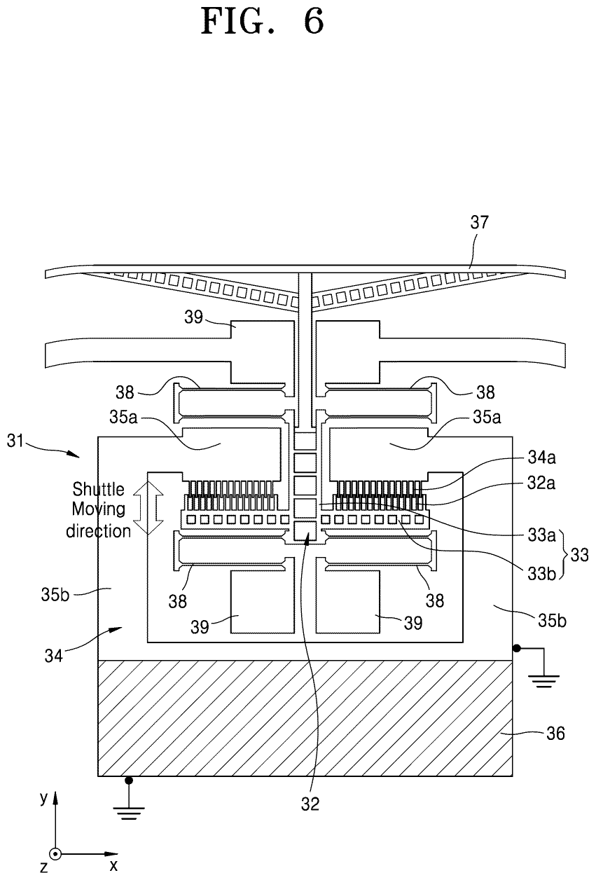

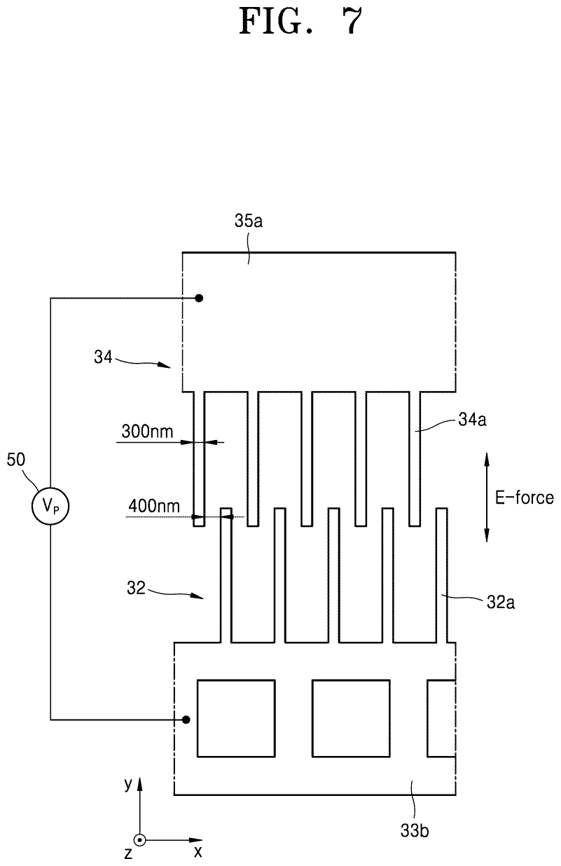

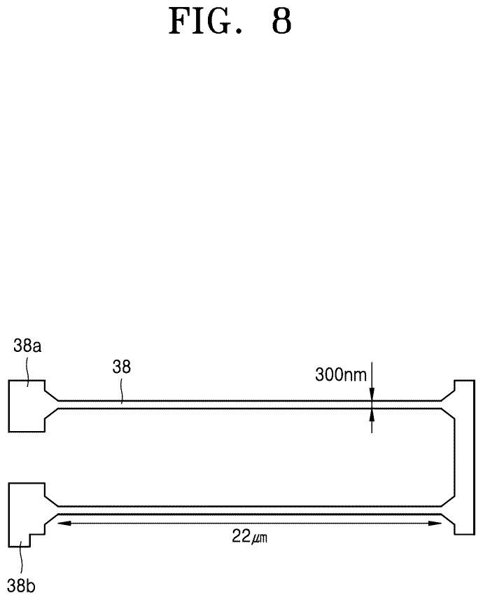

FIG. 6 is a plan view showing the first actuator 31 of the tunable phase shifter 30 applied to the tunable optical cavity 10 according to an embodiment. FIG. 7 is an enlarged view of a fixed comb 34a and a movable comb 32a of FIG. 6, and FIG. 8 is an enlarged view of a spring structure 38 of FIG. 6. The first actuator 31 described with reference to FIGS. 6 to 8 may be applied as the first actuator 31 of the tunable phase shifter 30 in the tunable optical cavity 10 according to the embodiment.

Referring to FIGS. 6 to 8, the first actuator 31 includes the first fixed part 34, the first movable part 32 provided to be able to move with respect to the first fixed part 34 and used to move the first movable waveguide 37 in the horizontal direction (y-axis direction) under the control of the controller 50, and an electrode 35c for electrical connection on the first fixed part 34. A driving voltage Vp may be applied to the first fixed part 34 through the electrode 35c under the control of the controller 50. The first movable part 32 may be, for example, electrically grounded. The first actuator 31 may be provided to be driven electrostatically. Accordingly, the first actuator 31 consumes electrical power only during operation, and the electrical power consumption during operation may also be very small.

Meanwhile, the first movable waveguide 37 may be the perturbation waveguide 19 or the cavity waveguide 17. In the tunable optical cavity 10 according to an embodiment, when the first movable waveguide 37 is the perturbation waveguide 19, the fixed waveguide 36 may be the cavity waveguide 17, and when the first movable waveguide 37 is the cavity waveguide 17, the fixed waveguide 36 may be the perturbing waveguide 19.

The first actuator 31 is provided to adjust a distance between the perturbation waveguide 19 and the cavity waveguide 17 in a direction in which the distance is closer to each other when the driving voltage Vp is applied.

To this end, the first fixed part 34 and the first movable part 32 may be formed with combs that engage with each other without collision in a direction in which the first movable part 32 moves, that is, the moving direction (y-axis direction) of the first movable part 32. The moving direction (y-axis direction) of the first movable part 32 may be the first moving direction, that is, the horizontal direction.

The first movable part 32 may include, for example, a shuttle 33 movable in the moving direction (y-axis direction) of the first actuator 31, and one end of the shuttle 33 may be coupled with the first movable waveguide 37.

The shuttle 33 may include a first shuttle part 33a formed in a shuttle moving direction (y-axis direction) and a second shuttle part 33b extending in a direction forming an angle with respect to the shuttle moving direction from both sides of the first shuttle part 33a, for example, a direction (x-axis direction) crossing the shuttle moving direction. The shuttle moving direction may be a horizontal direction in which the first movable waveguide 37 is moved. The first shuttle part 33a and the second shuttle part 33b of the shuttle 33 may be each partially patterned to have a plurality of grooves or through holes so that the first shuttle part 33a and the second shuttle part 33b each have a weight that exerts an appropriate actuation force. The shuttle moving direction may be the first moving direction.

A plurality of combs extending in the shuttle moving direction may be formed in the second shuttle part 33b to form a movable comb 32a. Between the second shuttle part 33b and the first movable waveguide 37, a comb anchor 35a of the first fixed part 34 that corresponds to the second shuttle part 33b and is spaced apart from the first shuttle part 33a may be formed, and on a side of the comb anchor 35a facing the second shuttle part 33b, a plurality of combs may be formed extending in the shuttle movement direction in a structure that engages with the movable com 32a without colliding with each other, thereby forming the fixed comb 34a.

The first fixed part 34 may include the fixed comb 34a connected to the comb anchor 35a and extending from a side of the comb anchor 35a in a moving direction and an anchor unit 35b patterned to form a space for accommodating the movable comb 32a extending from the second shuttle part 33b in the shuttle moving direction and the second shuttle part 33b. The electrode 35c for applying the driving voltage Vp of the first actuator 31 may be formed on the anchor unit 35b.

In this way, the first fixed part 34 may include the fixed comb 34a extending in the shuttle moving direction, and the first movable part 32 may include the movable comb 32a extending in the shuttle moving direction, and the fixed comb 34a and the movable comb 32a may be formed in a structure in which the fixed comb 34a and the movable comb 32a are engaged without colliding with each other. When the driving voltage Vp is applied to the first fixed part 34 and the first movable part 32 is electrically grounded, the first movable part 32 may move in the shuttle moving direction by an electrical force (E-force) formed between the fixed comb 34a and the movable comb 32a, and depending on the movement of the first movable part 32, an engagement length of the fixed comb 34a and the movable comb 32a may vary.

Meanwhile, the first movable part 32 may further include a plurality of spring structures 38 that provide restoring force. FIG. 6 illustrates an example in which the plurality of spring structures 38 have one end 38a connected to the first shuttle part 33a and other end 38b connected to a support unit 39 of the first movable part 32, and are arranged in parallel with the second shuttle part 33b, such that the plurality of spring structures 38 are symmetrical with each other with respect to first driving axis of the first shuttle part 33a and provide a restoring force in the first movable direction with the anchor 35a interposed therebetween. Here, the first driving axis of the first shuttle part 33a corresponds to an axis along which the first shuttle part 33a moves. The spring structure 38 may be provided in plural numbers to be symmetrical with respect to the first driving axis of the first shuttle part 33a of the first movable part 32. FIG. 6 shows an example of structure in which four spring structures 38 are symmetrical with respect to the first driving axis and arranged before and after an engaged structure portion of the movable comb 32a and the fixed comb 34a. The spring structure 38 may be provided in various shapes and arrangements to provide restoring force to the first movable part 32.

The first actuator 31 may be manufactured together with second actuators 21 and 41 of the tunable optical coupler 20 and 40, which will be described later. For example, a silicon oxide layer may be formed on a silicon substrate or a silicon on insulator (SOI) wafer may be used as a substrate, a silicon layer may be formed thereon, and then the silicon layer may be patterned to form the first movable part 32 and the first fixed part 34. The electrode 35c may be formed on the anchor unit 35b of the first fixed part 34. A portion of the silicon oxide layer may be removed through an etching process so that movable portions of the first movable part 32, that is, the shuttle 33, the movable comb 32a, and the spring structure 38, move in the horizontal direction (e.g., y-axis direction). The tunable optical cavity 10 according to the embodiment may include the first actuator 31 and the second actuators 21 and 41 formed as described above and may be implemented on a silicon photonic MEMS platform.

FIG. 7 is an enlarged view of the engagement structure of the fixed comb 34a and the movable comb 32a. As exemplarily illustrated in FIG. 7, the fixed comb 34a and the movable comb 32a may be formed such that a width of a comb pattern for forming the fixed comb 34a and the movable comb 32a may be, for example, about 300 nm, and a gap between the fixed comb 34a and the movable comb 32a may be, for example, about 400 nm, and when the driving voltage Vp is applied to the fixed comb 34a of the first fixed part 34, an electric force (E-force) is generated between the fixed comb 34a and the movable comb 32a, and thus, the first movable part 32 may be moved in the shuttle moving direction, that is, in the horizontal direction (e.g., y-axis direction). FIG. 8 is an enlarged view of the spring structure 38. As exemplarily illustrated in FIG. 8, the spring structure 38 may be formed to have a length of a micrometer scale and a pattern width of a nanometer scale. For example, the spring structure 38 may be formed to have a length of about 22 μm and a pattern width of about 300 nm. The numerical data in FIGS. 7 and 8 is merely an example, the embodiment is not limited thereto, and the numerical data may vary depending on the design conditions of the tunable optical cavity 10 according to an embodiment.

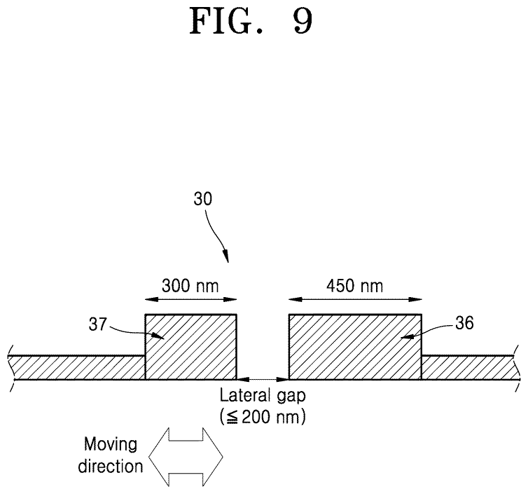

FIG. 9 is a cross-sectional view illustrating a design example of the fixed waveguide 36 and the first movable waveguide 37 of the tunable phase shifter 30.

Referring to FIG. 9, first portions of the fixed waveguide 36 and the first movable waveguide 37 through which light is transmitted may be formed to be thicker than remaining second portions, and the first portions of the fixed waveguide 36 and the first movable waveguide 37 may initially be formed to have a gap of about 200 nm. The first portion of the first movable waveguide 37 may be formed to have a width, for example, about 300 nm, and the first portion of the fixed waveguide 36 may be formed have a greater width, for example, about 450 nm. One of the movable waveguide 37 and the fixed waveguide 36 may be the perturbation waveguide 19 and the other one may be the cavity waveguide 17. Here, like the fixed waveguide 36 and the first movable waveguide 37 illustrated in FIGS. 5 and 9, first portions of the perturbation waveguide 19 and the cavity waveguide 17 where light is transmitted may be formed thicker than remaining second portions. Likewise, in the first optical coupler loop 13 and the second optical coupler loop 15 constituting the waveguide 11, first portions where light is transmitted may be formed thicker than remaining second portions. The waveguide 11 of the tunable optical cavity 10 according to the embodiment may be implemented on a silicon photonic MEMS platform.

The tunable phase shifter 30 may adjust a lateral gap between the perturbation waveguide 19 and the cavity waveguide 17 by moving the first movable waveguide 37, for example, the perturbation waveguide 19, in a first moving direction (horizontal direction) according to a driving voltage Vp applied to the first actuator 31 from the controller 50, and accordingly, an effective refractive index of an optical mode of the cavity waveguide 17 may be changed, and as a result, the phase of light may be shifted. The effective refractive index of the optical mode varies depending on the lateral gap, and the amount of phase shift may also vary accordingly. Also, because the effective refractive index varies depending on a wavelength, the amount of phase shift may vary depending on the wavelength.

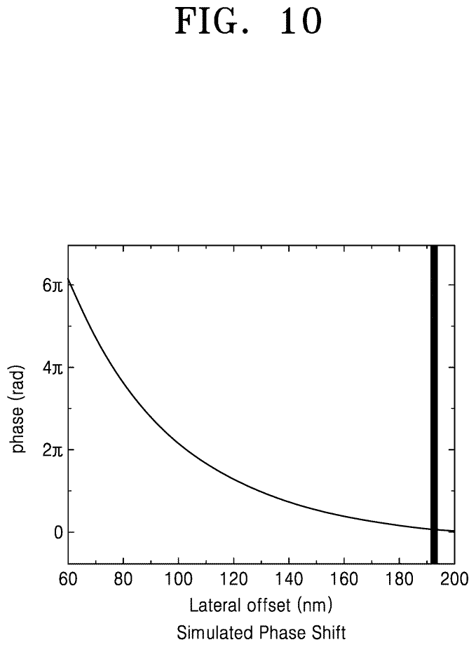

FIG. 10 is a graph showing simulation results of the phase shift amount by three tunable phase shifters 30 to which the design example of FIG. 9 is applied, respectively. The results in FIG. 10 show that, when a total length of the three perturbation waveguides 19 is about 300 μm and an initial lateral gap between the perturbation waveguide 19 and the cavity waveguide 17 is about 200 nm, the phase shift according to the reduction of the lateral gap between the perturbation waveguide 19 and the waveguide 17. It may be seen that a full free-spectral range (FSR), that is, phase tuning of 2π, is possible with only a movement of about 100 nm.

Referring again to FIGS. 1 to 3, in the tunable optical cavity 10 according to an embodiment, the first optical coupler loop 13 may be provided on the input terminal 11a side of the waveguide 11, and the second optical coupler loop 15 may be provided on the output terminal 11b side of the waveguide 11. The first optical coupler loop 13 may include a first waveguide portion 13a and a second waveguide portion 13b arranged in parallel with each other to occur an optical coupling and a loop waveguide portion 14 connecting the first waveguide portion 13a and the second waveguide portion 13b. The second optical coupler loop 15 may include a first waveguide portion 15a and a second waveguide portion 15b arranged in parallel with each other to occur an optical coupling, and a loop waveguide portion 16 connecting the first waveguide portion 15a and the second waveguide portion 15b. The first optical coupler loop 13 and the second optical coupler loop 15 may be provided to be symmetrical to each other or may be provided in different shapes. FIGS. 1 to 3 illustrate an example in which the first optical coupler loop 13 and the second optical coupler loop 15 are symmetrical to each other, but the embodiment is not limited thereto. The first optical coupler loop 13 and the second optical coupler loop 15 may each form a Sagnac Loop Reflector.

According to the tunable optical cavity 10 according to an embodiment, at least one of the first and second optical coupler loops 13 and 15 may be provided to form the tunable optical coupler 20 or 40, and the tunable optical coupler 20 or 40 may include the second actuator 21 or 41 to adjust an optical coupling ratio. In this case, the controller 50 may be provided to control a driving signal applied to the second actuators 21 and 41 to control optical coupling of the tunable optical couplers 20 and 40. FIGS. 1 and 3 illustrate that the first optical coupler loop 13 is provided to form the first tunable optical coupler 20, and the second optical coupler loop 15 is provided to form the second tunable optical coupler 40.

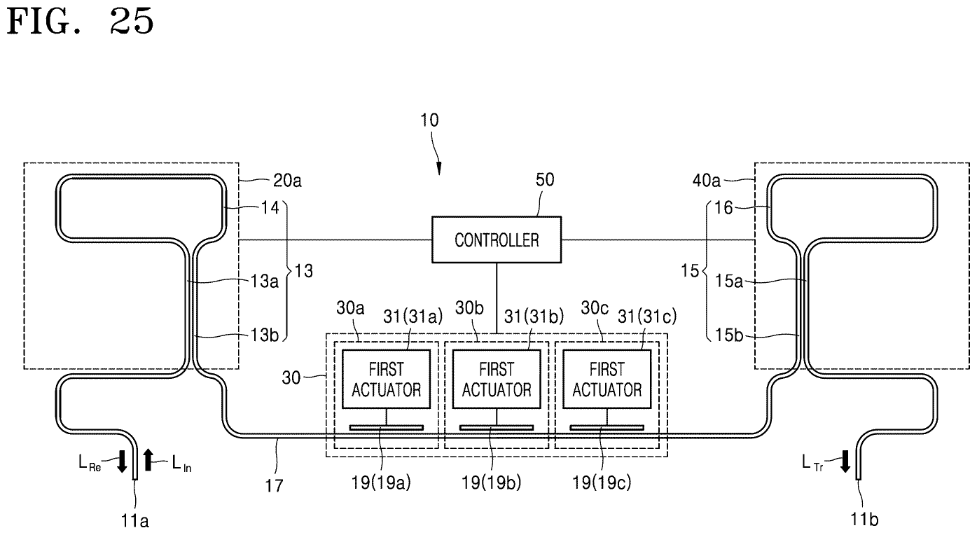

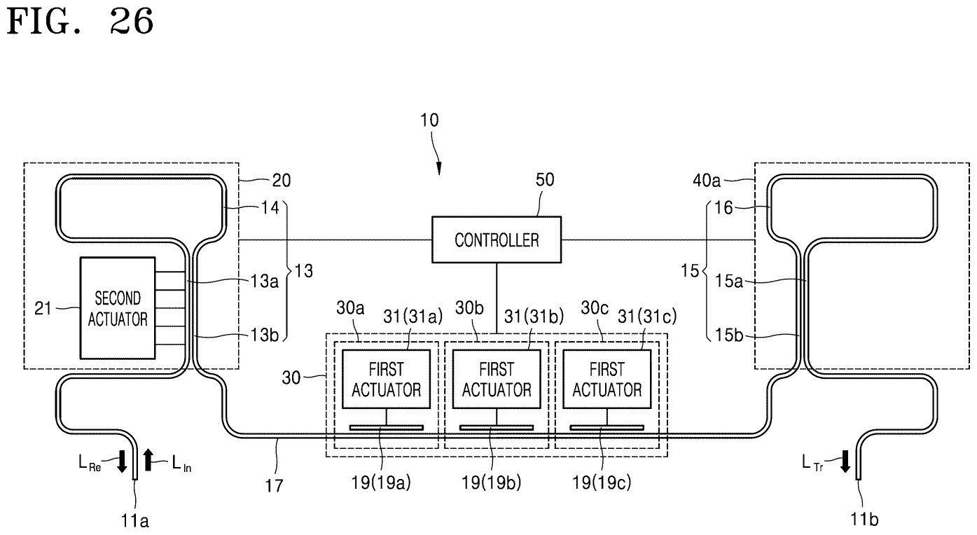

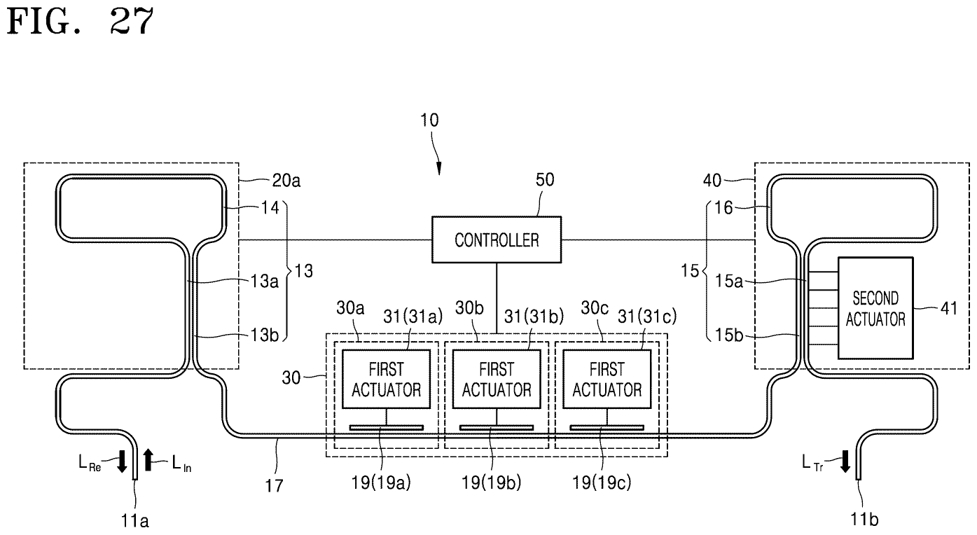

As illustrated in FIGS. 1 and 3, the tunable optical cavity 10 according to the embodiment may include the first tunable optical coupler 20 including the first optical coupler loop 13 provided on the input terminal 11a side of the waveguide 11 and the second tunable optical coupler 40 including the second optical coupler loop 15 provided on the output terminal 11b side of the waveguide 11. That is, the first tunable optical coupler 20 may include the first optical coupler loop 13 and the second actuator 21. Also, the second tunable optical coupler 40 may include the second optical coupler loop 15 and the second actuator 41. FIGS. 1 and 3 illustrate an example in which the tunable optical cavity 10 according to the embodiment includes the first tunable optical coupler 20 including the first optical coupler loop 13 and the second tunable optical coupler 40 including the second optical coupler loop 15, but the embodiment is not limited thereto. For example, as an example illustrated in FIG. 25, both the first optical coupler loop 13 and the second optical coupler loop 15 may be provided to form optical couplers 20a and 40a having a fixed optical coupling ratio without a second actuator. In addition, as examples illustrated in FIGS. 26 and 27, one of the first optical coupler loop 13 and the second optical coupler loop 15 may be provided to form the first tunable optical coupler 20 by including the second actuator 21 or alternatively, to form the second tunable optical coupler 40 by including the second actuator 41, and the other one may be provided to form an optical coupler 40a or 20a having a fixed optical coupling ratio. Hereinafter, an example in which the tunable optical cavity 10 according to the embodiment includes the first tunable optical coupler 20 including the first optical coupler loop 13 and the second tunable optical coupler 40 including a second optical coupler loop 15 will be described.

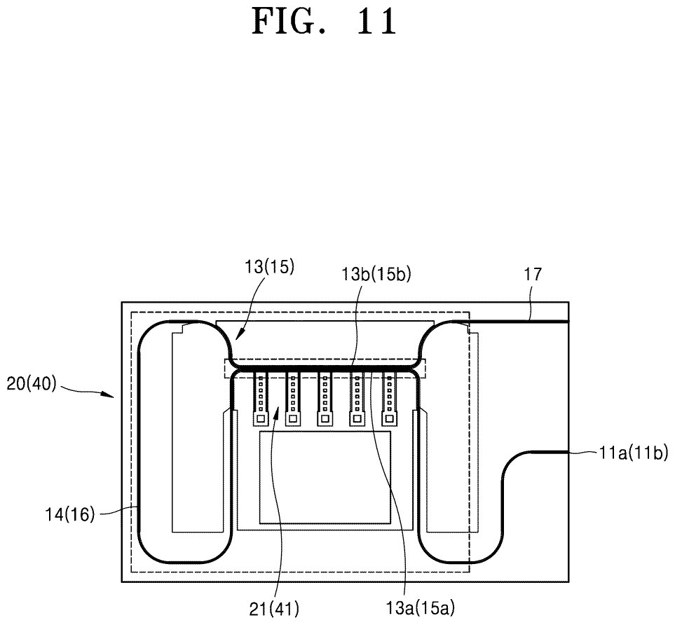

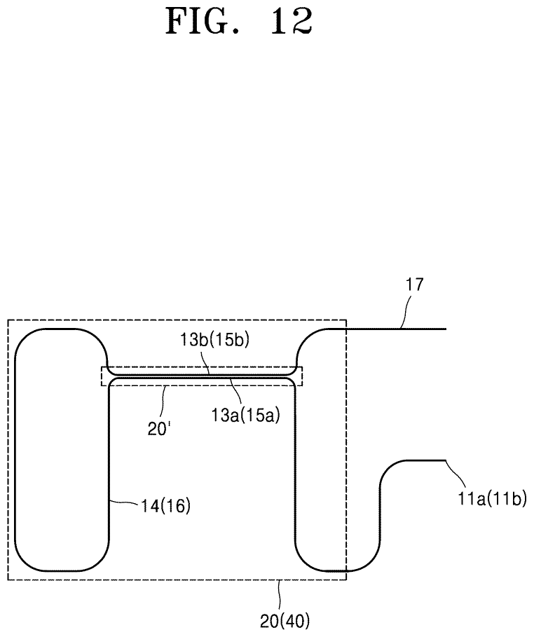

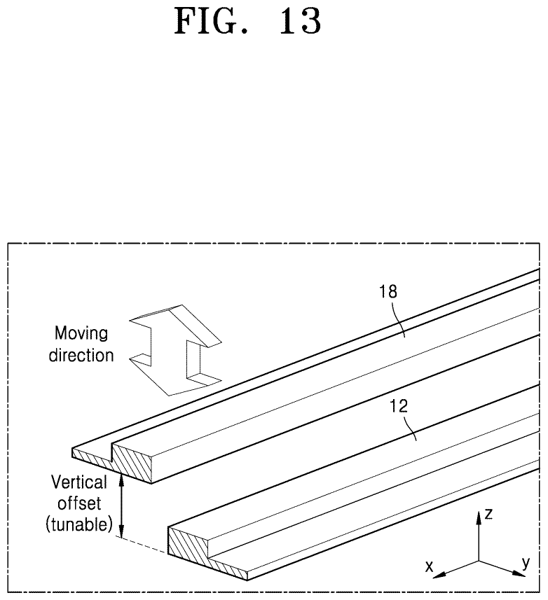

Hereinafter, a tunable optical coupler 20 (40) applied to the tunable optical cavity 10 according to the embodiment will be described in more detail with reference to FIGS. 11 to 18. The tunable optical coupler 20 (40) described with reference to FIGS. 11 to 18 may be the first tunable optical coupler 20 and/or the second tunable optical coupler 40 described above. FIGS. 11 and 12 exemplarily illustrate a structure corresponding to the first tunable optical coupler 20 and the first optical coupler loop 13 of FIG. 3 as an example. As illustrated in FIG. 3, the second tunable optical coupler 40 and the second optical coupler loop 15 may have a symmetrical shape with the first tunable optical coupler 20 and the first optical coupler loop 13.

FIG. 11 is an enlarged view of the tunable optical coupler 20 (40) that may be applied to the tunable optical cavity 10 according to the embodiment of FIG. 3. FIG. 12 illustrates an optical coupler loop 13 (15) of FIG. 11. FIG. 13 illustrates the movement of a second movable waveguide 18 in the vertical direction by driving a second actuator 21 (41) in the optical coupler loop 13 (15) of FIG. 11.

Referring to FIGS. 11 to 13, the tunable optical coupler 20 (40) may include the optical coupler loop 13 (15) and the second actuator 21 (41). The optical coupler loop 13 (15) may be the first optical coupler loop 13 or the second optical coupler loop 15 described above. The second actuator 21 (41) may be the second actuator 21 or the second actuator 41 described above.

The optical coupler loop 13 (15) of the tunable optical coupler 20 (40) may include a first waveguide portion 13a (15a) and a second waveguide portion 13b (15b), which are arranged in parallel with each other to occur an optical coupling and a loop waveguide portion 14 (16) connecting the first waveguide portion 13a (15a) and the second waveguide portion 13b (15b). When the tunable optical coupler 20 (40) is the first tunable optical coupler 20, the optical coupler loop 13 (15) may be the first optical coupler loop 13, and each of the first waveguide portion 13a (15a), the second waveguide portion 13b (15b), and the loop waveguide portion 14 (16) may be the first waveguide portion 13a, the second waveguide portion 13b, and the loop waveguide portion 14 described above. When the tunable optical coupler 20 (40) is the second tunable optical coupler 40, the optical coupler loop 13 (15) may be the second optical coupler loop 15, and each of the first waveguide portion 13a (15a), the second waveguide portion 13b (15b), and the loop waveguide portion 14 (16) may be the first waveguide portion 15a, the second waveguide portion 15b, and the loop waveguide portion 16 described above. For example, the first waveguide portion 13a (15a) is located between the input terminal 11a and the loop waveguide portion 14 or between the output terminal 11b and the loop waveguide portion 16, and the second waveguide portion 13b (15b) is located between the loop waveguide portion 14 (16) and the cavity waveguide 17. In FIGS. 11 and 12, an input (output) terminal 11a (11b) may be the input terminal (11a) or the output terminal 11b described above. The optical coupler loop 13 (15) constitutes a Sagnac Loop Reflector, and the loop waveguide portion 14 (16) corresponds to the Sagnac Cavity. In FIG. 12, reference number 20′ indicates a section in which the tunable optical coupler 20 (40) is formed, that is, a tunable optical coupler section. The second actuator 21 (41) may be provided to move one of the first waveguide portion 13a (15a) and the second waveguide portion 13b (15b) as the second movable waveguide 18 in a second moving direction to adjust optical coupling between the first waveguide portion 13a and the second waveguide portion 13b or between the first waveguide portion 15a and the second waveguide portion 15b. That is, the second actuator 21 (41) is provided to move either the first waveguide portion 13a (15a) or the second waveguide portion 13b (15b) as the second movable waveguide 18 in the second moving direction. For example, the second actuator 21 (41) may be provided to move the first waveguide portion 13a (15a) in the second moving direction as the second movable waveguide 18. Here, the second moving direction may be a moving direction orthogonal to a plane including the above-described first moving direction. For example, when the first moving direction is a horizontal direction, the second moving direction may be a vertical direction. Additionally, when the first moving direction is the vertical direction, the second moving direction may be the horizontal direction.

As exemplarily illustrated in FIGS. 1, 3, and 11, the second actuator 21 (41) may be provided to move the first waveguide portion 13a (15a) as the second movable waveguide 18 in the second moving direction, for example, in the vertical direction, as shown in FIG. 13. When the first waveguide portion 13a (15a) is moved by the second actuator 21/41, the second waveguide portion 13b (15b) may correspond to a fixed waveguide 12 in the tunable optical coupler 20 (40). As another example, the second actuator 21 (41) may be provided to move the second waveguide portion 13b (15b) as the second movable waveguide 18 in the second moving direction, for example, in the vertical direction. Here, a case in which the second actuator 21 (41) is provided to move the first waveguide portion 13a (15a), and the second direction in which the first waveguide portion 13a (15a) is moved is the vertical direction, is described as an example, but the embodiment is not limited thereto.

As exemplarily illustrated in FIGS. 3 and 11, the second actuator 21 (41) may be, for example, a MEMS-based actuator. The second actuator 21 (41) may include a second fixed part 25 and a second movable part 23 in which the second movable part is provided to be able to move with respect to the second fixed part 25 and may move may move the first waveguide portion 13a (15a), that is, the second movable waveguide 18 according to control of the controller 50. The second movable part 23 may be combined with the first waveguide portion 13a (15a). The second actuator 21 (41) may move the first waveguide portion 13a (15a) coupled to the second movable part 23 in the second moving direction, for example, in the vertical direction by moving the second movable part 23 with respect to the second fixed part 25 by a driving voltage Vc applied from the controller 50.

As exemplarily illustrated in FIG. 13, when the second movable waveguide 18, for example, the first waveguide portion 13a (15a) is moved in the second moving direction, that is, in the vertical direction by the driving voltage Vc applied to the second actuator 21 (41) from the controller 50, a vertical offset between the movable waveguide 18 and the fixed waveguide 12, for example, between the first waveguide portion 13a and the second waveguide portion 13b or between the first waveguide portion 15a and the second waveguide portion 15b is tunable, and as a result, the optical coupling efficiency between the first waveguide portion 13a and the second waveguide portion 13b or between the first waveguide portion 15a and the second waveguide portion 15b may be adjusted.

According to the tunable optical cavity 10 according to an embodiment, the driving voltage Vc from the controller 50 may be applied, for example, to the second fixed part 25 of the second actuator 21 (41), and the second movable part 23 of the second actuator 21 (41) may be electrically grounded. The second actuator 21 (41) may be provided to be driven electrostatically. Accordingly, the second actuator 21 (41) may consume electrical power only during operation, and electrical power consumption during operation may also be very small.

As exemplarily illustrated in FIG. 13, the second movable waveguide 18 and the fixed waveguide 12, for example, the first waveguide portion 13a and the second waveguide portion 13b or the first waveguide portion 15a and the second waveguide portion 15b may have the same cross-sectional size. As another example, the first waveguide portion 13a and the second waveguide portion 13b or the first waveguide portion 15a and the second waveguide portion 15b may have different cross-sectional sizes.

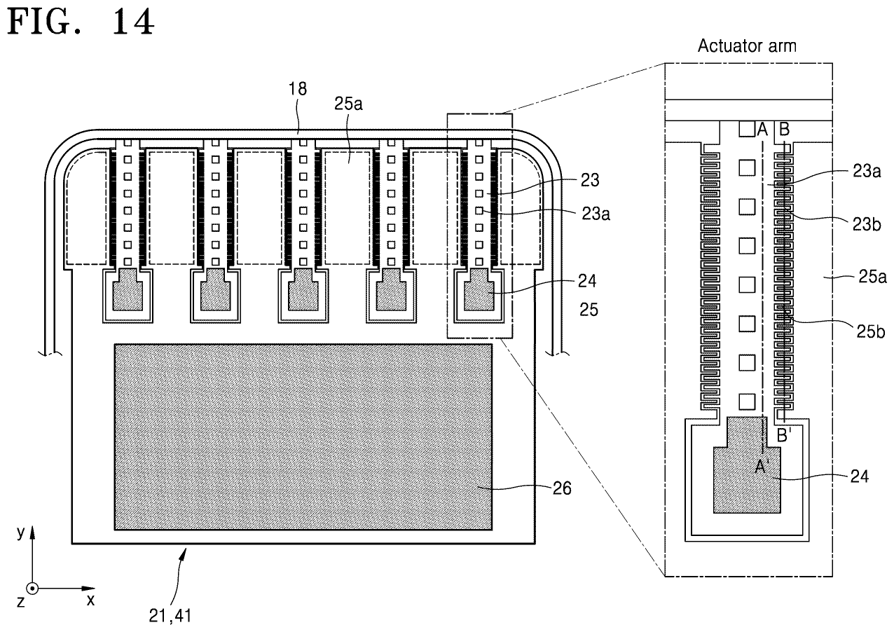

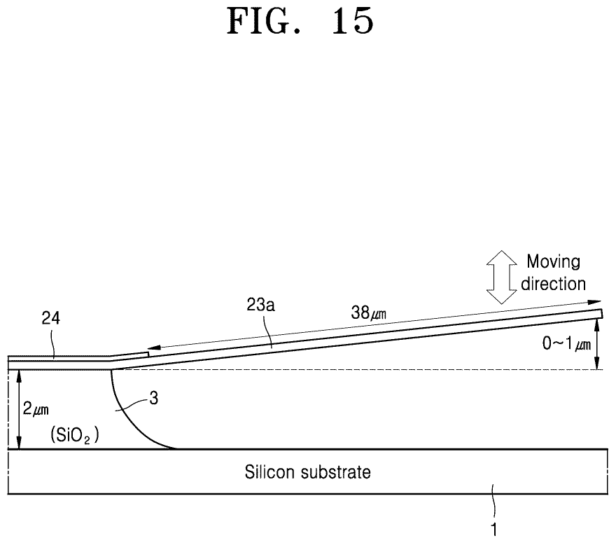

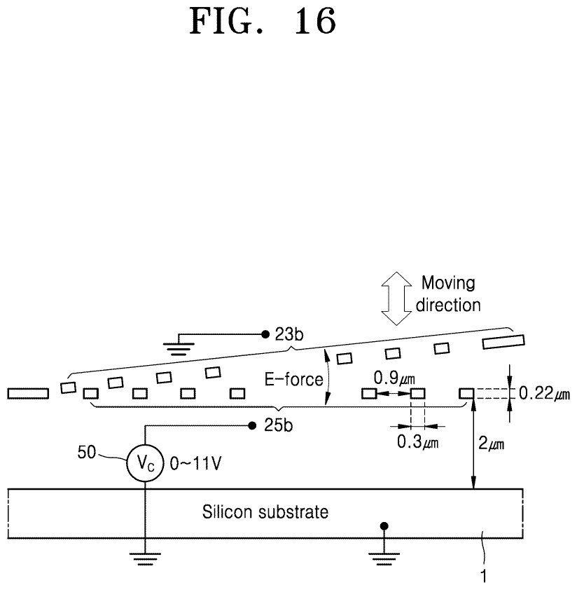

FIG. 14 is a schematic plan view illustrating an example of the second actuator 21 (41) of the tunable optical coupler 20 (40) applied to the tunable optical cavity 10 according to an embodiment. FIG. 15 is a cross-sectional view taken along line A-A′ of FIG. 14, and FIG. 16 is a cross-sectional view taken along line B-B′ of FIG. 14.

Referring to FIGS. 14 to 16, the second actuator 21 (41) may include the second fixed part 25, the second movable part 23, and electrodes 24 and 26 for electrical connection on the second movable part 23 and the second fixed part 25. The second movable part 23 may be provided to be movable with respect to the second fixed part 25 and to move the second movable waveguide 18, that is, the first waveguide portion 13a (15a) or the second waveguide portion 13b (15b) in the second moving direction, for example, in the vertical direction (z-axis direction) according to the control of the controller 50. A driving voltage Vc may be applied to the second fixed part 25 through the electrode 26 under the control of the control unit 50. The second movable part 23 may be electrically grounded through the electrode 24. The second actuator 21 (41) may be provided to be driven electrostatically. Accordingly, the second actuator 21 (41) may consume electrical power only during operation, and electrical power consumption during operation may also be very small.

The second fixed part 25 and the second movable part 23 may have combs that engage each other without collision in a direction forming an angle with respect to second driving axis of the second movable part 23, for example, in a direction crossing the second driving axis. The second driving axis may be parallel to the y-axis. In this case, the second moving direction may be vertical, and the second movable waveguide 18 may be moved in the vertical direction.

For example, the second movable part 23 may include an actuator arm 23a in the longitudinal direction, and an end of the actuator arm 23a may be combined or connected to the second movable waveguide 18. The longitudinal direction (y-axis direction) of the actuator arm 23a may be parallel to the second driving axis. A plurality of combs extending in a direction crossing the second driving axis (x-axis direction) may be formed on both sides of the actuator arm 23a to constitute a movable comb 23b.

The second actuator 21 (41) may include a plurality of actuator arms 23a, which may be partially patterned to have a weight that exerts an appropriate actuation force and may include a plurality of grooves or through holes. A comb anchor 25a of the second fixed part 25 may be formed between the actuator arms 23a. A plurality of combs extending in a direction crossing the second driving axis of the actuator arm 23a to engage with the movable comb 23b without colliding each other may be formed on a lateral portion of the comb anchor 25a, and thus, may constitute a fixed comb 25b.

Also, the second actuator 21 (41) may be provided so that the second movable waveguide 18 is tunable in the vertical direction (z-axis direction) by a plurality of actuator arms 23a. The comb anchors 25a may be formed on both sides of the actuator arm 23a, and the fixed comb 25b may extend from the comb anchor 25a in a direction crossing the second driving axis (x-axis direction) so as to engage with the movable comb 23b without collision.

In this way, the second fixed part 25 may include the fixed comb 25b, the second movable part 23 may include the movable comb 23b, and the fixed comb 25b and the movable comb 23b may be formed to engage each other without colliding. When the driving voltage Vc is applied between the second fixed part 25 and the second movable part 23 and, for example, the second movable part 23 is electrically grounded, as shown in FIGS. 15 and 16, the actuator arm 23a of the second movable part 23 may be moved in the vertical direction by an electrical force (E-force) formed between the fixed comb 25b and the movable comb 23b. Accordingly, by moving the second movable waveguide 18 in the vertical direction, as shown in FIG. 13, a size of the vertical offset between the fixed waveguide 12 and the second movable waveguide 18 may be adjusted, thereby adjusting optical coupling therebetween. In the tunable optical cavity 10 according to an embodiment, when the second movable waveguide 18 is the first waveguide portion 13a (15a), the fixed waveguide 12 may be the second waveguide portion 13b (15b), and when the second waveguide 18 is the second waveguide portion 13b (15b), the fixed waveguide 12 may be the first waveguide portion 13a (15a).

The second actuator 21 (41) may be formed, for example, as follows. A silicon oxide layer may be formed on a silicon substrate to a predetermined thickness, for example, a thickness of about 2 μm, and a process of forming a silicon layer may be performed. A silicon on insulator (SOI) wafer may be used as a substrate for manufacturing the second actuator 21 (41). The silicon layer may be formed of, for example, crystalline silicon and may be formed to a submicron thickness, for example, a thickness of about 220 nm. Thereafter, the silicon layer may be patterned to form the second fixed part 25 and the second movable part 23 in a structure in which the fixed comb 25b and the movable comb 23b are engaged without colliding each other, and, for electrical connection to drive the second movable part 23, the electrodes 24 and 26 may be formed on portions of the silicon layer corresponding to a hinge axis portion of the second movable part 23 and one side of the second fixed part 25. The movable portion of the second movable part 23, that is, an end of the actuator arm 23a, may be formed to be combined to the second movable waveguide 18. Here, being formed to be combined may include being formed integrally. As exemplarily illustrated in FIGS. 15 and 16, a portion of a silicon oxide layer 3 may be removed through an etching process so that a movable portion of the second movable part 23, that is, the actuator arm 23a is moved in the vertical direction.

FIG. 15 illustrates an example in which the actuator arm 23a is formed to be spaced apart from a substrate 1, for example, a silicon substrate, by a thickness of the silicon oxide layer 3, which is about 2 μm, and have a length of, for example, about 38 μm, and is moved in a range of about 0 μm to about 1 μm in the vertical direction (second moving direction) depending on the applied driving voltage Vc. FIG. 16 illustrates an example in which a thickness of a silicon layer forming the fixed comb 25b and the movable comb 23b is approximately 0.22 μm, an interval of comb patterns is approximately 0.9 μm, a width of the comb pattern is approximately 0.3 μm, the movable comb 23b of the second movable part 23 is grounded, and the driving voltage Vc within a range of about 0 V to about 11 V is applied from the controller 50 to the fixed comb 25b of the second fixed part 25. The substrate 1 may also be grounded.

The material and numerical data in FIGS. 15 and 16 are only examples, the embodiment is not limited thereto, and may vary depending on the design conditions of the tunable optical cavity 10 according to the embodiment.

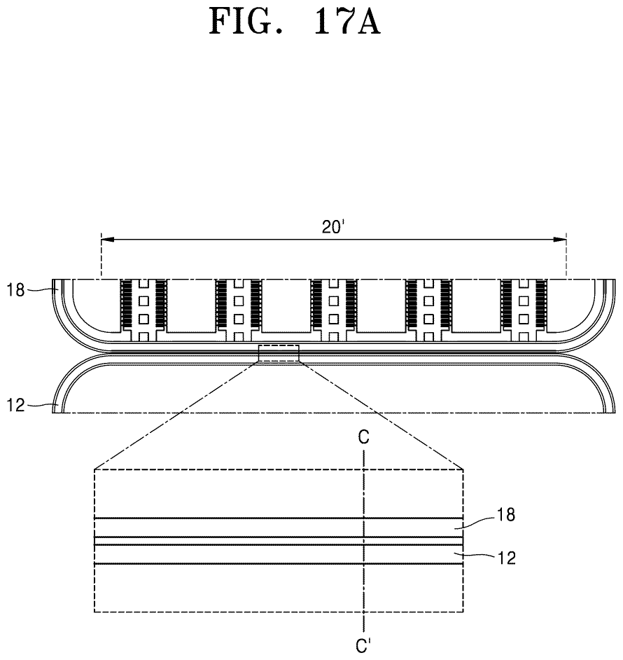

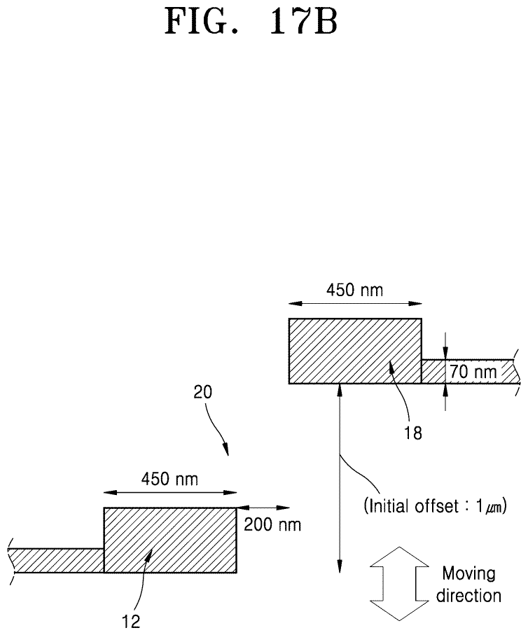

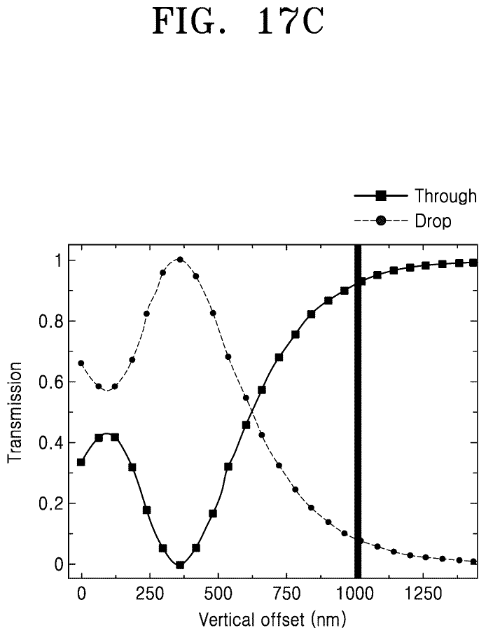

FIGS. 17A and 17B illustrate a design example of the tunable optical coupler 20 (40) of the tunable optical cavity 10 according to an embodiment, wherein FIG. 17A is a plan view of a section 20′ in which the tunable optical coupler 20 (40) is formed, and FIG. 17B is a schematic cross-sectional view taken along line C-C′ of FIG. 17A. FIG. 17C is a graph showing the change in optical coupling efficiency according to the driving of the tunable light coupler 20 (40) to which the design example of FIGS. 17A and 17B are applied. In FIG. 17C, the horizontal axis represents the size (unit:nm) of the vertical offset between the fixed waveguide 12 and the second movable waveguide 18, and the vertical axis represents a change in optical transmission (arbitrary unit (a.u.)) of the fixed waveguide 12 and the second movable waveguide 18 according to the vertical offset. The fixed waveguide 12 may be one of the first waveguide portion 13a (15a) and the second waveguide portion 13b (15b), and the second movable waveguide 18 may be the other one. In FIG. 17C, Drop and Through denote light coupled and transmitted from one waveguide portion of the first waveguide portion 13a (15a) and the second waveguide portion 13b (15b) and light proceeding to the one waveguide portion, respectively.

Referring to FIGS. 17A and 17B, the tunable optical coupler section 20′ may be provided to correspond to a length of, for example, about 150 μm. In the tunable optical coupler section 20′, each of the fixed waveguide 12 and the second movable waveguide 18 may be formed such that a first portion through which light is transmitted is thicker than a remaining second portion, and the first portion may be formed to have a first width and form a gap smaller than the first width. For example, the first portions of the fixed waveguide 12 and the second movable waveguide 18 may be formed to have a width of about 450 nm, respectively, and a gap therebetween of about 200 nm. The second portions of the fixed waveguide 12 and the second movable waveguide 18 may be formed to have a relatively small thickness, for example, a thickness of about 70 nm.

The tunable optical coupler 20 (40) may adjust the size of the vertical offset between the fixed waveguide 12 and the second movable waveguide 18 by moving the second movable waveguide 18 in the second moving direction (vertical direction) according to a driving voltage Vc applied to the second actuator 21 from the controller 50, and accordingly, the optical coupling between the fixed waveguide 12 and the second movable waveguide 18 may be adjusted. That is, as described above with reference to FIGS. 11 to 13, the size of the vertical offset between the first waveguide portion 13a (15a) and the second waveguide portion 13b (15b) of the optical coupler loop 13 (15) may be adjusted, and accordingly, the optical coupling between the first waveguide portion 13a (15a) and the second waveguide portion 13b (15b) may be adjusted. For example, a rate at which light proceeding to the first waveguide portion 13a (15a) is coupled to the second waveguide portion 13b (15b) may vary depending on the size of the vertical offset. Also, a rate at which light proceeding to the second waveguide portion 13b (15b) is coupled to the first waveguide portion 13a (15a) may vary depending on the size of the vertical offset.

As in FIG. 17C, an initial value of the vertical offset may be about 1 μm (i.e., 1000 nm). When the size of the vertical offset corresponds to a reference separation distance, for example, about 370 nm, the optical coupling rate of the fixed waveguide 12 and the second movable waveguide 18 may become maximum, and when the vertical offset is greater or less than the reference separation distance, the optical coupling rate from the fixed waveguide 12 to the second movable waveguide 18 or the optical coupling rate from the second movable waveguide 18 to the fixed waveguide 12 may decrease. When the size of the vertical offset, that is, the separation distance, is, for example, about 620 nm, the optical coupling rate is about 0.5, for example, approximately half of the light proceeding to the second movable waveguide 18 may be coupled to the fixed waveguide 12, or approximately half of the light proceeding to the fixed waveguide 12 may be coupled to the second movable waveguide 18. When the size of the vertical offset is greater than about 620 nm, optical coupling from the second movable waveguide 18 to the fixed waveguide 12 or from the fixed waveguide 12 to the second movable waveguide 18 may further decrease.

That is, when the vertical offset is a reference separation distance, the optical coupling rate between the first waveguide portion 13a (15a) and the second waveguide portion 13b (15b) may be maximum, and when the vertical offset is greater or less than the reference separation distance, optical coupling rate from the first waveguide portion 13a (15a) to the second waveguide portion 13b (15b) or from the second waveguide portion 13b (15b) to the first waveguide portion 13a (15a) may decrease. When the size of the vertical offset, that is, the separation distance, is, for example, about 620 nm, the optical coupling rate is about 0.5, for example, approximately half of the light proceeding to the first waveguide portion 13a (15a) may be coupled to the second waveguide portion 13b (15b) or approximately half of the light proceeding to the second waveguide portion 13b (15b) may be coupled to the first waveguide portion 13a/15a. When the size of the vertical offset is greater than about 620 nm, optical coupling from the first waveguide portion 13a (15a) to the second waveguide portion 13b (15b) or from the second waveguide portion 13b (15b) to the first waveguide portion 13a (15a) may further decrease.

When the size of the vertical offset corresponds to the reference separation distance, the second actuator 21 (41) may be, for example, in an off state or in a state in which a reference driving voltage is applied.

When the tunable optical coupler 20 (40) has the dimensions of the design example of FIGS. 17A and 17B, as may be seen from FIG. 17C, when the size of the vertical offset is about 370 nm, for example, optical coupling between the first waveguide portion 13a (15a) and the second waveguide portion 13b (15b) may be maximized, and when the size of the vertical offset is greater or less than about 370 nm, only part of light is coupled, and when the vertical offset exceeds a critical distance, an optical coupling may not be occurred. When the design example of FIGS. 17A and 17B is applied, the vertical offset for adjusting optical coupling may be controlled, for example, in the range of about 0 nm to about 620 nm or about 0 nm to about 1000 nm. The size of the vertical offset between the first waveguide portion 13a (15a) and the second waveguide portion 13b (15b) where optical coupling is maximized may vary depending on design conditions of the tunable optical coupler 20 (40).

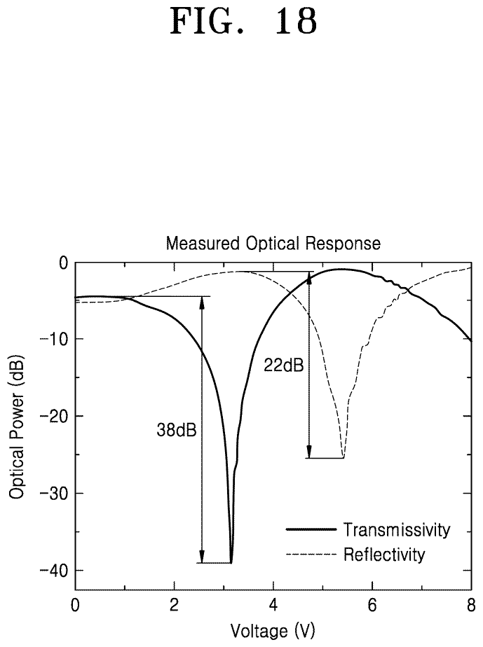

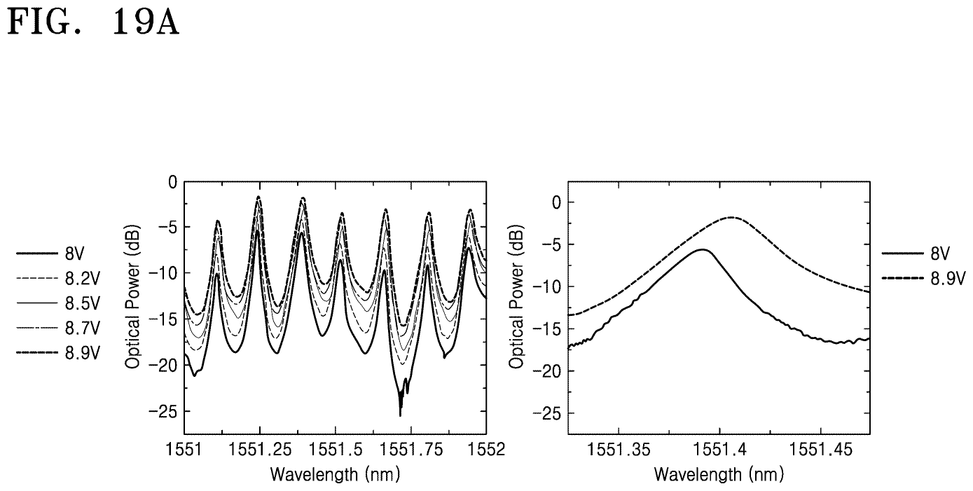

FIG. 18 is a graph showing the measured transmissivity and reflectivity of the tunable optical coupler 20 (40) applied to the tunable optical cavity 10 according to the embodiment according to the applied voltage. In FIG. 18, a response is measured for a configuration of the single tunable optical coupler 20 (40).

For example, light proceeding from the input (output) terminal 11a (11b) in FIGS. 11 and 12 to the tunable optical coupler section 20′ proceeds as described below through coupling and/or no coupling in the tunable light coupler section 20′. For example, it is considered that at least part of light (hereinafter referred to as first coupled light) among light traveling toward the first waveguide portion 13a (15a) is optically coupled to the second waveguide portion 13b (15b). Among the light proceeding to the first waveguide portion 13a (15a), remaining light that is not optically coupled to the second waveguide portion 13b (15b) is referred to as first uncoupled light. The first coupled light optically coupled from the first waveguide portion 13a (15a) to the second waveguide portion 13b (15b) proceeds to the second waveguide portion 13b (15b) and the loop waveguide portion 14 (16), and then, meets the first waveguide portion 13a (15a) of the tunable optical coupler section 20′. The first uncoupled light proceeds to the first waveguide portion 13a (15a) and the loop waveguide portion 14 (16), and then, meets the second waveguide portion 13b (15b) of the tunable optical coupler section 20′.

At least part of the first coupled light (hereinafter referred to as second coupled light) that meets the first waveguide portion 13a (15a) is optically coupled to the second waveguide portion 13b (15b) and proceeds to the cavity waveguide 17 through the tunable optical coupler section 20′. Remaining light of the first coupled light (hereinafter referred to as second uncoupled light) that meets the first waveguide portion 13a (15a) proceeds through the first waveguide portion 13a (15a) toward the input (output) terminal 11a (11b).

At least part of the first uncoupled light (hereinafter referred to as third coupled light) that meets the second waveguide portion 13b (15b) is optically coupled to the first waveguide portion 13a (15a) and proceeds toward the input (output) terminal 11a (11b). Remaining light of the first uncoupled light (hereinafter referred to as third uncoupled light) that meets the second waveguide portion 13b (15b) proceeds through the second waveguide portion 13b (15b) and proceeds to the cavity waveguide 17 through the tunable optical coupler section 20′.

Therefore, when the light proceeds to the first waveguide portion 13a (15a) of the tunable optical coupler section 20′, the second coupled light and the third uncoupled light proceed through the second waveguide portion 13b (15b) and proceed to the cavity waveguide 17 through the tunable optical coupler section 20′, and thus may correspond to light transmitted through the tunable optical coupler 20 (40). When the light proceeds to the first waveguide portion 13a (15a) of the tunable optical coupler section 20′, the second uncoupled light and the third coupled light proceed in opposite direction in the first waveguide portion 13a (15a) towards the input (output) terminal 11a (11b), and thus may correspond to light reflected from the tunable optical coupler 20 (40).

In FIG. 18, the transmissivity represents a ratio of the transmitted light (for example, corresponding to a sum of the second coupled light and the third uncoupled light) proceeding to the cavity waveguide 17 through tunable optical coupler section 20′ with respect to the light proceeding from the input (output) terminal 11a (11b) to the tunable optical coupler section 20′. The reflectivity represents a ratio of light (for example, corresponding to a sum of the second uncoupled light and the third coupled light) reflected from the tunable optical coupler 20 (40) with respect to the light proceeding from the input (output) terminal 11a (11b) to the tunable light coupler section 20′. As shown in FIG. 18, the transmissivity and reflectivity may be changed according to a voltage applied to the second actuator 21 (41) of the tunable optical coupler 20 (40), and it may be seen that extinctions of the transmissivity and reflectivity are large values of about 38 dB and about 22 dB, respectively. Also, it may be seen that the reflectivity of almost 100% may be achieved.

In this way, the tunable optical coupler 20 (40) may adjust the size of the vertical offset of the waveguide 12 and the second movable waveguide 18 by moving the second movable waveguide 18 in the second moving direction (vertical direction) according to a driving voltage Vc applied to the second actuator 21 (41) from the controller 50, and accordingly, the optical coupling between the fixed waveguide 12 and the second movable waveguide 18 may be adjusted, and as a result, the transmissivity and reflectivity of the tunable optical coupler 20 (40) may be adjusted.

For example, referring to FIGS. 1 to 3, when light L_{In} proceeds from the input terminal 11a to the first waveguide portion 13a of the first tunable optical coupler 20, the light transmitted the first tunable optical coupler 20 proceeds through the cavity waveguide 17 toward the second tunable optical coupler 40 and is transmitted and/or reflected from the second tunable optical coupler 40. The light transmitted the second tunable optical coupler 40 proceeds through an extension portion of the first waveguide portion 15a of the second tunable optical coupler 40 and is output as transmission light L_{Tr} through the output terminal 11b. Returned light reflected from the second tunable optical coupler 40 proceeds through the cavity waveguide 17 again and proceeds to the first tunable optical coupler 20 and is transmitted and/or reflected from the first tunable optical coupler 20. Among the returned light, light reflected from the first tunable optical coupler 20 proceeds through the cavity waveguide 17 again. Among the returned light, the light transmitted through the first tunable optical coupler 20 proceeds through an extension portion of the first waveguide portion 13a of the first tunable optical coupler 20 and is output as reflection light L_{Ref} through the input terminal 11a.

In this way, each of the first tunable optical coupler 20 and the second tunable optical coupler 40 may constitute a reflector, and the reflectivity of each of the first tunable optical coupler 20 and the second tunable optical coupler 40 may be adjusted according to a voltage applied to the second actuator 21 (41). Accordingly, the first tunable optical coupler 20 including the first optical coupler loop 13, the second tunable optical coupler 40 including the second optical coupler loop 15, and the cavity waveguide 17 in which an effective refractive index of an optical mode is tunable may constitute the tunable optical cavity 10, for example, a Fabry-Perot tunable cavity. In addition, the first tunable optical coupler 20 including the first optical coupler loop 13 and the second tunable optical coupler 40 including the second optical coupler loop 15 each may configure a Sagnac loop reflector with tunable reflectivity. That is, the tunable optical cavity 10 according to the embodiment may implement a Fabry-Pérot tunable cavity including two Sagnac loop reflectors with tunable reflectivity and a cavity waveguide 17 in which an effective refractive index of an optical mode is tunable, and accordingly, a length of the effective optical path is tunable.

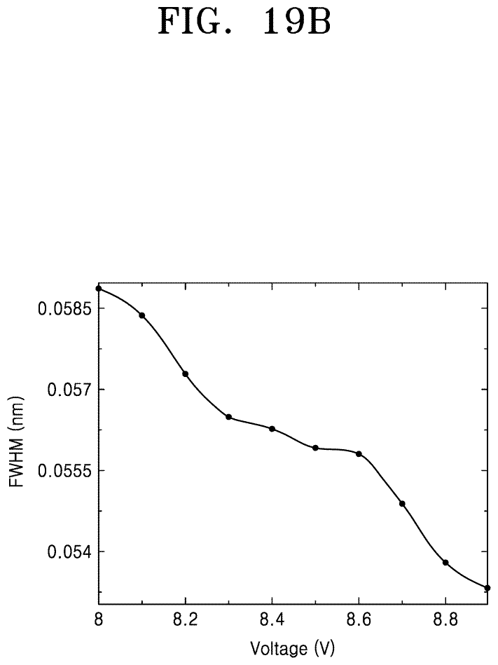

FIGS. 19A and 19B are graphs showing a measured transmission spectrum response and a measured transmission linewidth FWHM of the tunable optical cavity 10 according to an embodiment. FIG. 19A shows the transmission spectrum response of the tunable optical cavity 10 according to an embodiment while the first tunable optical coupler 20 on the input terminal 11a side is fixed and various voltages are applied to the second tunable optical coupler 40 on the output terminal 11b side. FIG. 19B shows the measured transmission linewidth FWHM of the tunable optical cavity 10 according to the embodiment while various voltages are applied to the second tunable optical coupler 40 on the output terminal 11b side.

As may be seen in FIG. 19A, because the wavelength at which the transmissivity is maximum varies depending on the voltage applied to the second actuator 41 of the second tunable optical coupler 40, it may be confirmed that a transmission linewidth may be precisely controlled by controlling the reflectivity of the second tunable optical coupler 40 on the output terminal 11b side. As illustrated in FIG. 19B, by controlling the reflectivity of the tunable optical cavity 10 according to an embodiment, the transmission linewidth of the tunable optical cavity 10 according to an embodiment may be finely adjusted from about 0.059 nm to about 0.053 nm depending on a control voltage, and thus, the transmission linewidth may be precisely controlled.

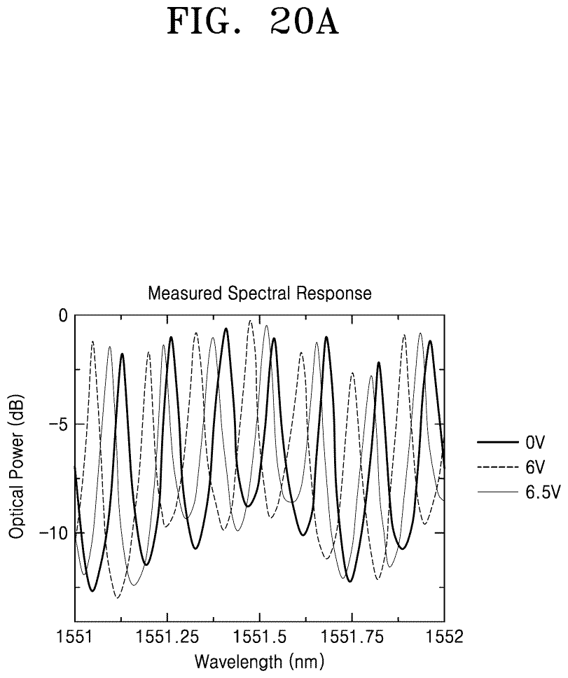

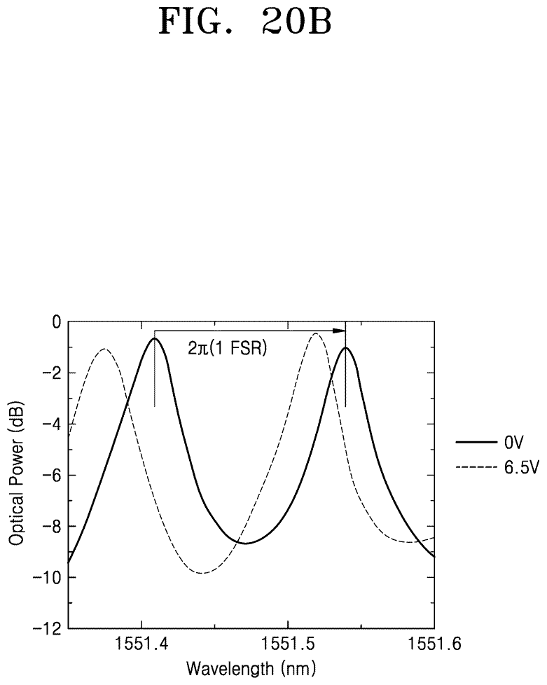

FIG. 20A illustrates a shift of a resonance peak of a transmission signal of the tunable optical cavity 10 according to an embodiment, and FIG. 20B illustrates an enlarged partial section of FIG. 20A.

As illustrated in FIGS. 20A and 20B, it may be confirmed that as a voltage applied to the first actuator 31 of the tunable phase shifter 30 is adjusted, the resonance peak in the full free-spectral range (FSR) may be adjusted. As may be seen in FIGS. 20A and 20B, a resonance wavelength of the tunable optical cavity 10 according to the embodiment may be precisely controlled, the resonance peak may be shifted by about 0.2 nm or more, and 1 FSR, that is, the shift of the resonance peak of 2π or more is possible. In FIGS. 20A and 20B, it is shown as an example the shift in the resonance peak of the transmission signal of the tunable optical cavity 10 when the applied voltages are 0V, 6V, and 6.5V, respectively, but the embodiment is not limited thereto.

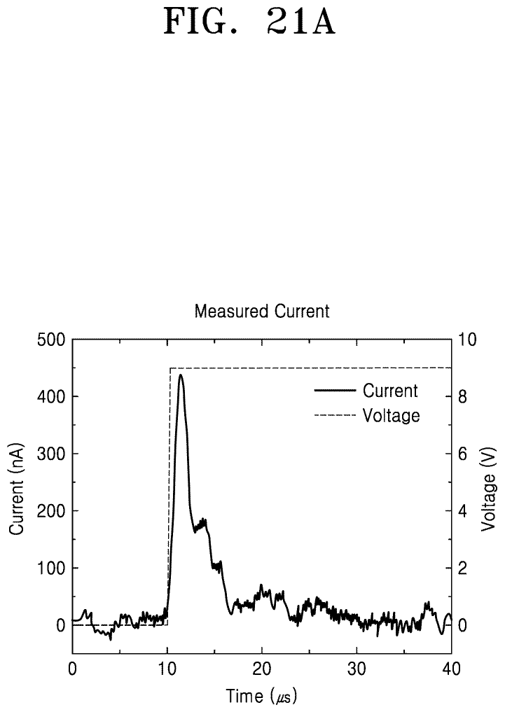

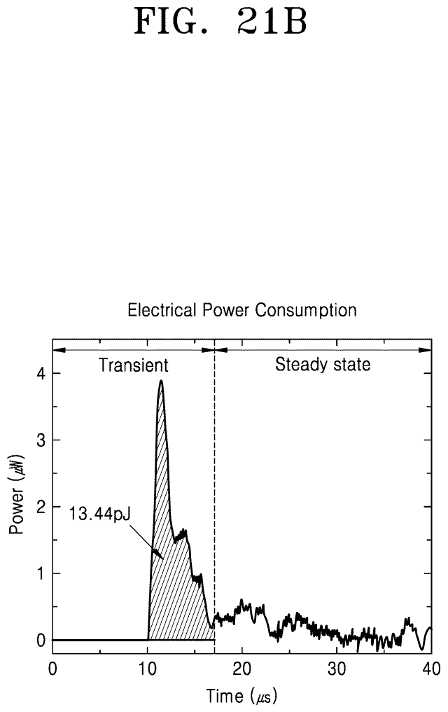

FIGS. 21A and 21B are graphs showing current changes and electrical power consumption measured at the tunable optical coupler 20 (40) over time when a voltage is applied to the tunable optical coupler 20 (40) applied to the tunable optical cavity 10 according to an embodiment, respectively. As shown in FIG. 21A, for example, when a step voltage of about 9V is applied (0V→9V) to the tunable optical coupler 20 (40), a current measured from the tunable optical coupler 20 (40) rises sharply in the transient section and then decreases, and a current is barely measured in the steady state section, as in the case when the applied voltage is 0V. This shows that electrical energy is consumed to move the tunable optical coupler 20 (40) from the moment when the voltage is applied to approximately the end of the transient section, and that there is almost no electrical energy consumption in other sections. Here, the transient section in FIG. 21B may represent the section until the moment when a meaningful current measurement value exists in the tunable optical coupler 20 (40) while the voltage is applied. As exemplarily illustrated in FIG. 21B, about 13.44 pJ of electrical energy is required for about 10 μs to move the second movable waveguide 18, for example, the first waveguide portion 13a (15a) by applying a voltage to the second actuator 21 (41) of the tunable optical coupler 20 (40). Here, 1 pJ denotes 10⁻¹² J, and 1 J corresponds to 1 watt (W)·1 second(s). Accordingly, the tunable optical coupler 20 (40) may be driven with static power of approximately nanowatt nW scale.

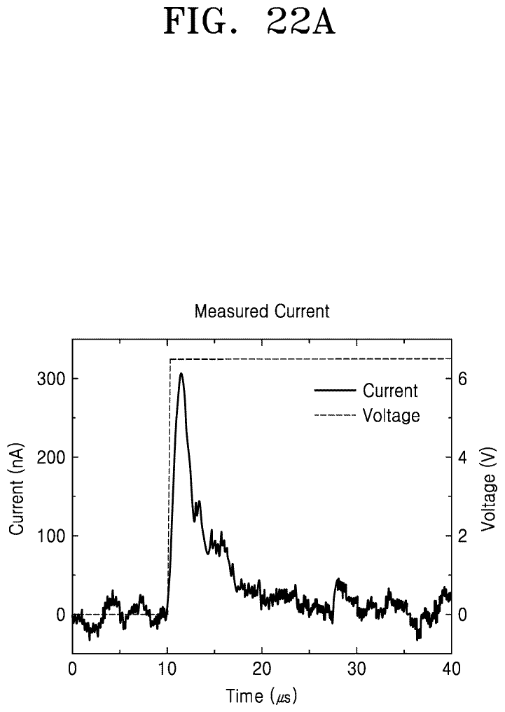

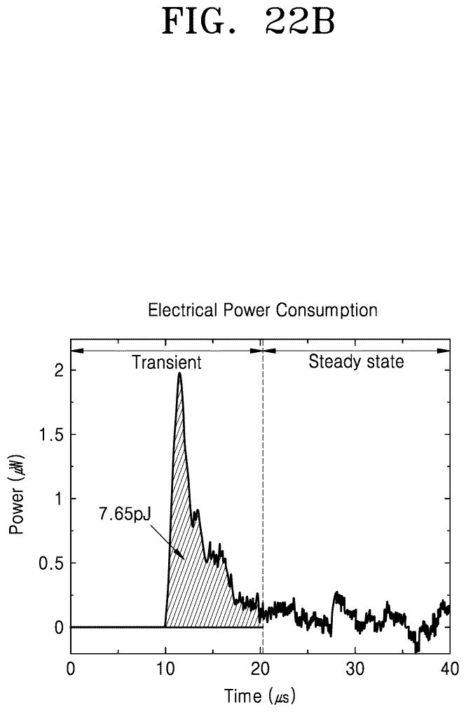

FIGS. 22A and 22B are graphs showing current changes and electrical power consumption measured in the tunable phase shifter 30 over time when a voltage is applied to the tunable phase shifter 30 applied to the tunable optical cavity 10 according to an embodiment, respectively. As shown in FIG. 22A, for example, if a step voltage of about 6.5V is applied (0V→6.5V) to the tunable phase shifter 30, a current measured in the tunable phase shifter 30 rises sharply in the transient section and then decreases, and a current is barely measured in the steady state section, as in the case when the applied voltage is 0V. This shows that electrical energy is consumed to move the tunable phase shifter 30 from the moment when the voltage is applied to approximately the end of the transient section, and that there is almost no electrical energy consumption in other sections. In FIG. 22B, the transient section may represent a section until the moment when a meaningful current measurement value exists in the tunable phase shifter 30 while the voltage is applied. As exemplarily illustrated in FIG. 22B, about 7.65 pJ of electrical energy is required for about 10 μs to move the first movable waveguide 14, for example, the perturbation waveguide 19 by applying a voltage to the first actuator 31 of the tunable phase shifter 30. Accordingly, the tunable phase shifter 30 may be driven with static power of approximately nanowatt nW scale. For example, if the tunable phase shifter 30 includes a plurality of tunable phase shifters, each of the plurality of tunable phase shifters may be moved with static power of approximately nanowatt nW scale.

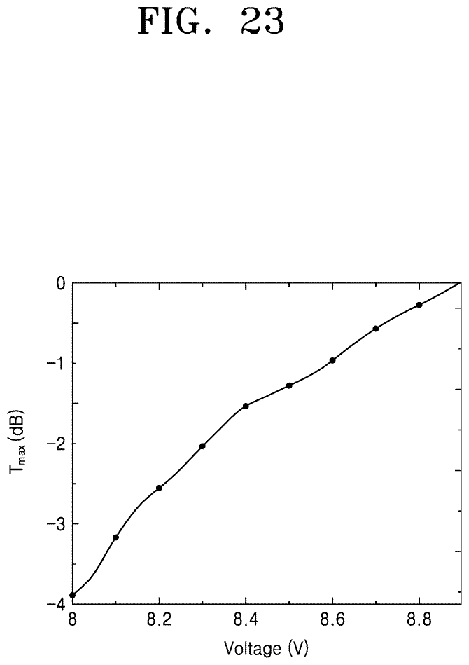

FIG. 23 shows the transmission power measured at the resonance peak when various voltages are applied to the second tunable optical coupler 40 at the output terminal 11b side of the tunable optical cavity 10 according to an embodiment. As shown in the graph of FIG. 23, the maximum transmission power Tmax may increase from about −3.85 dB to about 0 dB by increasing the applied voltage.

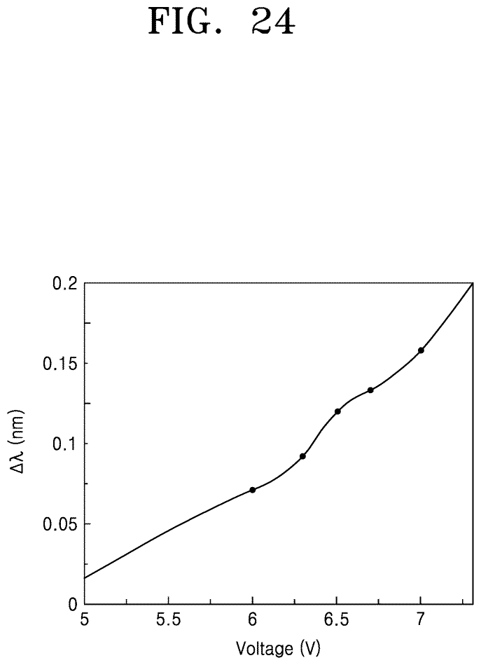

FIG. 24 shows a resonance wavelength shift Δλ measured when various voltages are applied to the tunable phase shifter 30 of the tunable optical cavity 10 according to an embodiment. As shown in the graph of FIG. 24, the resonance peak wavelength may be shifted by as much as about 0.2 nm, which is an entire free spectral range by applying a voltage of about 7 V or more.

As described above, the total static electrical power consumption of the adjustable elements, such as the tunable optical coupler 20 (40) and the tunable phase shifter 30 applied to the tunable optical cavity 10 according to the embodiment may be, for example, about 10 nW or less. Therefore, for example, a fully tunable cavity, for example, a fully tunable Fabry-Perot cavity may be implemented based on a silicon photonic MEMS having static electrical power consumption of about 10 nW or less.

Meanwhile, as an example, it is described that, in the tunable optical cavity 10 according to the embodiment, the tunable phase shifter 30 is provided to move the first movable waveguide 37, for example, the perturbation waveguide 19 in the first moving direction, for example, in the horizontal direction by including the first actuator 31 described above, and the tunable optical coupler 20 (40) is provided to move the second movable waveguide 18, for example, the first waveguide portion 13a (15a) of the optical coupler loop 13 (15) in the second moving direction, for example, in the vertical direction by including the second actuator 21 (41), but the embodiment is not limited thereto.

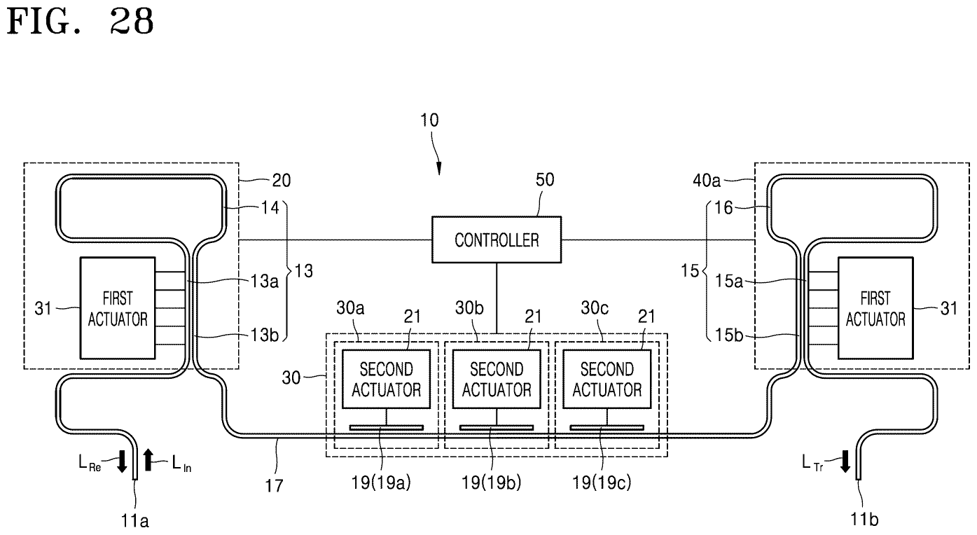

For example, as exemplarily illustrated in FIG. 28, in the tunable optical cavity 10 according to an embodiment, the tunable phase shifter 30 may include the second actuator 21 described above, and the tunable optical coupler 20 (40) may include the first actuator 31 described above.

In this case, as described above with reference to FIGS. 14 to 17b, combs that engage each other without collision may be formed on the second fixed part 25 and the second movable part 23 of the second actuator 21 applied to the tunable phase shifter 30 in a direction that forms an angle with respect to the second driving axis of the second movable part 23, for example, in a direction crossing the second driving axis, and, for example, the perturbation waveguide 19 may be moved in the second moving direction, for example, in the vertical direction. As described above with reference to FIGS. 6 to 9, combs that engage each other without collision may be formed on the first fixed part 34 and the first movable part 32 of the first actuator 31 applied to tunable optical coupler 20 (40) in a direction in which the first movable part 32 is moved, that is, in the direction of moving the first movable part 32, and, for example, the first waveguide portion 13a (15a) of the optical coupler loop 13 (15) may be moved in the first moving direction, for example, in the horizontal direction.

In this way, the tunable phase shifter 30 may be provided to move the second movable waveguide 18, for example, the perturbation waveguide 19 in the second moving direction, for example, in the vertical direction by including the second actuator 21 described above, the tunable optical coupler 20 (40) may be provided to move the first movable waveguide 37, for example, the first waveguide portion 13a (15a) of the optical coupler loop 13 (15) in the first moving direction, for example, in the horizontal direction by including the first actuator 31 described above.

As another example, in the tunable optical cavity 10 according to an embodiment illustrated in FIG. 28, as in the modified examples illustrated in FIGS. 25 to 27, at least one of the first optical coupler loop 13 and the second optical coupler loop 15 may be modified to form a fixed optical coupler without the first actuator 31. Because these modified examples may be inferred from FIGS. 25 to 28, repetitive description and illustration are omitted.

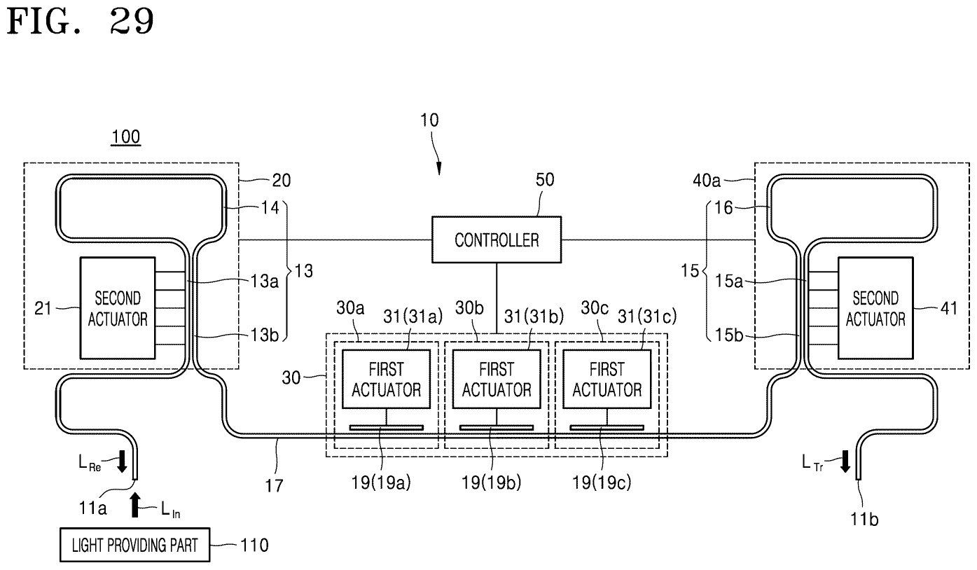

FIG. 29 is a schematic diagram showing an optoelectronic system 100 including the tunable optical cavity 10 according to an embodiment. FIG. 29 illustrates an example of applying the tunable optical cavity 10 shown in FIG. 1 but is not limited thereto. The tunable optical cavity 10 of various embodiments described above may be applied to the optoelectronic system 100 according to an embodiment.

Referring to FIG. 29, the optoelectronic system 100 may include the tunable optical cavity 10 and a light providing part 110.

The light providing part 110 may provide light to the tunable optical cavity 10 through the input terminal 11a. For example, the light providing part 110 may include a semiconductor light-emitting device, for example, a semiconductor laser device, or may include another type of laser light source. Here, the semiconductor laser device may include a surface-emitting semiconductor laser device or an edge-emitting semiconductor laser device.

When the light providing part 110 includes a semiconductor laser device or another type of laser light source, by an operation of the tunable optical cavity 10, laser light having a finely adjusted peak wavelength and fine linewidth may be output as transmission light through the output terminal 11b of the tunable optical cavity 10.

As another example, the light providing part 110 may include a semiconductor light-emitting device such as an LED or may include another type of radiating light source, and in this case, by an operation of the tunable optical cavity 10, light having a desired peak wavelength and a fine linewidth may be output as transmission light through the output terminal 11b of the tunable optical cavity 10.

On the other hand, when the light providing part 110 is provided with a semiconductor light-emitting device such as a semiconductor laser device or LED, for example, the light providing part 110 may be integrated on the same substrate as the tunable optical cavity 10 by a semiconductor process. As another example, the light providing part 110 may include a separately manufactured semiconductor light-emitting device and may be integrated to configure the optoelectronic system 100 together with the tunable optical cavity 10.

Also, the optoelectronic system 100, for example, may further include a connection waveguide (not shown) between the light providing part 110 and the tunable optical cavity 10. At this time, the connection waveguide may be formed on the same layer as the waveguide 11 of the tunable optical cavity 10, may be formed on a different layer, or may be formed separately. Additionally, the connection waveguide may be a transmission waveguide or an amplification waveguide including an amplification medium. Light output from the semiconductor light-emitting device of the light providing unit 110 may be transmitted to the tunable optical cavity 10 through the connection waveguide. As another example, the optoelectronic system 100 may not include a connection waveguide between the light providing part 110 and the tunable optical cavity 10, and the light output from the semiconductor light-emitting device may be transmitted to the tunable optical cavity 10 through the input terminal 11a after traveling through a free space.

According to the optoelectronic system 100 according to the various embodiments, for example, the light providing part 110 may include a semiconductor laser device as a semiconductor light-emitting device or another type of laser light source, and laser light provided from the light providing part 110 may be transmitted to the tunable optical cavity 10 through the input terminal 11a. The transmitted laser light may undergo fine adjustment of linewidth, resonance peak wavelength adjustment, and/or transmission power adjustment in the tunable optical cavity 10, and may be output through the output terminal 11b of the tunable optical cavity 10. The reflection light L_{Re} reflected in the tunable optical cavity 10 and output through the input terminal 11a may or may not be transmitted to the light providing part 110. When the reflection light L_{Re} is transmitted to the light providing part 110, the reflection light L_{Re} may act as feedback light. As another example, the optoelectronic system 100 may further include a monitoring photodetector that detects reflection light L_{Re} and may use the reflection light L_{Re} as monitoring light.

The optoelectronic system 100 according to the embodiment as described above may be able to perform fine linewidth adjustment and/or fine resonance peak wavelength adjustment by driving the tunable optical cavity 10 at low electrical power, unwanted shifts and hopping of an emission laser wavelength due to thermal crosstalk of the tuning element may be prevented. The optoelectronic system 100 according to the embodiment may be applied to various optical devices, optical circuits, and systems including the same, and may be modified as needed. The tunable optical cavity according to the embodiments described above and the optoelectronic systems including the tunable optical cavity may be implemented with hardware components, software components, or any combination of hardware and software components. For example, the tunable optical cavity according to the embodiments and the optoelectronic systems including the tunable optical cavity may be implemented by using a processing device of one or more general-purpose computers or special-purpose computers, such as a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device may execute an operating system (OS) and one or more software applications running on the OS.

The processing device may also access, store, manipulate, process, and generate data in response to the execution of software. The processing device may include a plurality of processing elements and/or a plurality of types of processing elements. For example, the processing device may include a plurality of processors or one processor and one controller. It is also possible to include other processing configurations, such as parallel processors.

Software may include a computer program, a code, instructions, or any combination of one or more of thereof, and may configure the processing device to be operated as desired or may command the processing device independently or collectively. Software and/or data may be permanently or temporarily embodied in any type of machine, component, physical device, virtual equipment, computer storage medium or computer storage device or in propagated signal wave to be interpreted by a processing device or to provide instructions or data to the processing device. Software may be distributed over computer systems connected by a network and stored or executed in a distributed manner. Software and data may be stored in one or more computer-readable recording media.

The tunable optical cavity and the optoelectronic system including the tunable optical cavity according to the embodiment consume electrical power only while the actuators of the tunable phase shifter and tunable optical coupler are in operation, and the electrical power consumption during operation is also very small, and thus, fine linewidth adjustment and/or fine resonance peak wavelength adjustment, etc. may be possible with low electrical power.

The actuator applied to the tunable optical cavity according to the embodiment may be implemented on a silicon photonic MEMS platform because the movable part and the fixed unit may be formed by patterning a silicon layer.

Although the tunable optical cavity described above has been described with reference to the embodiments illustrated in the drawings, the embodiments are merely exemplary, and it will be understood by one of ordinary skill in the art that various modifications and equivalent embodiments may be made therefrom. Therefore, the disclosed embodiments are to be considered in descriptive sense only, and not for purposes of limitation. The scope of the disclosure is in the claims rather than the above descriptions, and all differences within the equivalent scope should be construed as being included in the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A tunable optical cavity comprising:
a waveguide provided to include a first optical coupler loop provided on an input terminal side, a second optical coupler loop provided on an output terminal side, and a cavity waveguide therebetween;
a tunable phase shifter configured to shift a phase of light proceeding the cavity waveguide by including a perturbation waveguide arranged in parallel with a straight waveguide portion of the cavity waveguide and a first actuator that moves one of the cavity waveguide and the perturbation waveguide in a first moving direction as a first movable waveguide; and
a controller configured to control a driving signal applied to the first actuator to adjust an effective cavity length between the first optical coupler loop and the second optical coupler loop by adjusting an amount of light phase shift by the tunable phase shifter,
wherein each of the first and second optical coupler loops includes a first waveguide portion and a second waveguide portion arranged in parallel with each other and a loop waveguide portion connecting the first waveguide portion and the second waveguide portion, and an optical coupling occurs between the first waveguide portion and the second waveguide portion.

2. The tunable optical cavity of claim 1, wherein the first moving direction is a horizontal direction or a vertical direction.

3. The tunable optical cavity of claim 1, wherein the perturbation waveguide and the cavity waveguide have different cross-sectional sizes, or the perturbation waveguide has a less cross-sectional size than the cavity waveguide.

4. The tunable optical cavity of claim 1, wherein the first movable waveguide is the perturbation waveguide.

5. The tunable optical cavity of claim 1, wherein the first actuator is a micro-electromechanical system (MEMS)-based actuator.

6. The tunable optical cavity of claim 5, wherein the first actuator is provided to adjust in a direction in which the cavity waveguide and the perturbation waveguide become closer when a driving signal is input thereto.

7. The tunable optical cavity of claim 5, wherein the first actuator is provided to move one of the cavity waveguide and the perturbation waveguide in the first moving direction,
wherein the first actuator includes a first fixed part and a first movable part provided to be movable with respect to the first fixed part to move one of the cavity waveguide and the perturbation waveguide as the first movable waveguide in the first moving direction, and
the first fixed part and the first movable part are formed with combs engaging with each other without collision in a direction in which the first movable part moves or in a direction forming an angle with respect to a first driving axis of the first movable part.

8. The tunable optical cavity of claim 7, wherein a driving signal is applied from the controller to the first fixed part of the first actuator, and the first movable part is electrically grounded and driven in an electrostatic manner.

9. The tunable optical cavity of claim 1, wherein the tunable phase shifter includes a plurality of tunable phase shifters, and
the perturbation waveguide includes a plurality of perturbation waveguides arranged along the cavity waveguide in parallel with a straight waveguide portion of the cavity waveguide and spaced apart from each other to form the plurality of tunable phase shifters, and the first actuator includes a plurality of first actuators provided to correspond to each of the plurality of perturbation waveguides,
wherein each of the plurality of tunable phase shifters includes one perturbation waveguide and one first actuator.

10. The tunable optical cavity of claim 1, wherein the first optical coupler loop is provided to form a first tunable optical coupler, and the second optical coupler loop is provided to form a second tunable optical coupler,
wherein each of the first and second tunable optical couplers includes a second actuator provided to move one of the first waveguide portion and the second waveguide portion of each of the first and second optical coupler loops as a second movable waveguide in a second moving direction crossing a plane including the first moving direction to adjust an optical coupling between the first waveguide portion and the second waveguide portion.

11. The tunable optical cavity of claim 10, wherein the second moving direction is a vertical direction or the horizontal direction, and
the second actuator is provided to move one of the first waveguide portion and the second waveguide portion as the second movable waveguide in the second moving direction.

12. The tunable optical cavity of claim 11, wherein the second actuator includes a second fixed part and a second movable part for moving the second movable waveguide in the second moving direction under control of the controller,
wherein the second fixed part and the second movable part have combs engaging with each other without collision in a direction forming an angle with respect to a second driving axis of the second movable part or in a direction in which the second movable part moves.

13. The tunable optical cavity of claim 12, wherein a driving signal is applied to the second fixed part of the second actuator, and the second movable part is electrically grounded and driven in an electrostatic manner.

14. The tunable optical cavity of claim 1, wherein any one of the first and second optical coupler loops is provided to form a tunable optical coupler,
wherein the tunable optical coupler includes a second actuator provided to move any one of the first and second waveguide portions arranged in parallel with each other in the optical coupler loop as a second movable waveguide in a second moving direction crossing a plane including the first moving direction to adjust an optical coupling between the first waveguide portion and the second waveguide portion.

15. The tunable optical cavity of claim 14, wherein the second moving direction is a vertical direction or a horizontal direction, and
the second actuator is provided to move one of the first waveguide portion and the second waveguide portion as the second movable waveguide in the second moving direction.

16. The tunable optical cavity of claim 15, wherein the second actuator includes a second fixed part and a second movable part for moving the second movable waveguide in the second moving direction under control of the controller,
wherein the second fixed part and the second movable part have combs engaging with each other without collision in a direction forming an angle with respect to the second driving axis of the second movable part or in a direction in which the second movable part moves.

17. The tunable optical cavity of claim 16, wherein a driving signal is applied to the second fixed part of the second actuator, and the second movable part is electrically grounded and driven in an electrostatic manner.

18. The tunable optical cavity of claim 14, wherein other of the first and second optical coupler loops is a fixed type.

19. An optoelectronic system comprising:
the tunable optical cavity of claim 1; and
a light providing part configured to provide light input to the tunable optical cavity through an input terminal of the tunable optical cavity.

20. The optoelectronic system of claim 19, wherein the light providing part is configured to provide laser light.
